(19) United States
(12) Patent Application Publication
(10) Pub. No.: US 2002/0092340 A1
(43) Pub. Date: Jul. 18, 2002

(54) Cantilever array sensor system

(75) Inventors: Craig Prater, Santa Barbara, CA (US); Charles R. Meyer, Santa Barbara, CA (US); Chanmin Su, Ventura, CA (US); James Robert Massie, Santa Barbara, CA (US); Kenneth Lawrence Babcock, Santa Barbara, CA (US); Mary Gertrude Turner, Tucson, AZ (US)

Correspondence Address: Jay G. Durst, Boyle Fredrickson Newholm Stein & Gratz S.C., 250 East Wisconsin Avenue, Suite 1030, Milwaukee, WI, 53202, US

(73) Assignee: VEECO INSTRUMENTS INC.

(21) Appl. No.: 09/999,681

(22) Filed: Oct. 30, 2001

Related U.S. Application Data
(60) Provisional application No. 60/244,798, filed on Oct. 30, 2000.

(51) Int. Cl. G01N 22/00

(52) U.S. Cl. 73/24.02

(57) ABSTRACT

An integrated cantilever sensor array system that accurately detects and measures the presence of target substances in various environmental conditions. The integrated cantilever sensor array system comprises a cantilever sensor measurement head, a cantilever sensor system for measuring the oscillatory properties of the cantilevers and a measurement chamber. The measurement head includes a cantilever array having at least one cantilever, a light source and a detector positioned to detect incoming light reflected by the cantilevers within the cantilever array. The cantilever sensor system measures the oscillatory properties generated by the cantilevers within the cantilever array. The system includes the cantilever array and a detection system that measures a signal related to the bending of the cantilever. In addition, optional components such as a high frequency clock, Q-Control, may be added to more accurately measure the oscillation of the cantilevers within the cantilever array. The measurement chamber includes a flow cell, a cantilever sensor array mounted within the flow cell. The flow cell is designed to minimize dead volume and unwanted air bubbles within the cell, which may reduce accuracy of measurement.

### CROSS-REFERENCE TO RELATED APPLICATION

This application is based on and claims priority from U.S. Provisional Patent Application Serial No. 60/244,798 which was filed on Oct. 30, 2000 and which was entitled “CANTILEVER ARRAY SENSOR SYSTEM”.

### BACKGROUND OF THE INVENTION

1. Field of the Invention

This invention is directed to cantilever-based sensors and systems used to measure static and dynamic properties such as deflection, resonant frequency, phase, and amplitude as a function of time in response to various target substances.

2. Discussion of Related Art

Micro-cantilevers or cantilevers are known in the art for use in detecting the presence of target substances. This is done by measuring a change in the cantilever's deflection, or resonant frequency, when the cantilever is exposed to a target substance.

Cantilevers originally developed for atomic force microscopes have been used for a number of years as chemical sensing devices. In atomic force microscopy, the cantilever is used as an extremely sensitive detector of forces between the AFM tip and a sample surface. These cantilevers are also very sensitive to the forces and mass of molecules that attach to the cantilever surface. To use a cantilever as a chemical sensor, the cantilever is typically treated so that one or more of its surfaces are coated with a sensing layer that will adsorb, bind to, or otherwise react with the target chemical to be detected. When a target chemical binds to the cantilever, it will cause a change in the mass, stress, or temperature of the cantilever. These changes can be detected by measuring the motion of the cantilever as it is exposed to the target chemical.

There are three basic modes of operation of cantilever sensors that have been demonstrated to date. The first mode, may be referred to as AC mass detection. In this mode, the cantilever is oscillated at or near its resonant frequency. As the target chemical binds to the sensing layer on the cantilever surface, the mass of the oscillating body increases and the resonant frequency decreases. By measuring the shift in resonant frequency, one can estimate the amount of material bound to the cantilever.

A second mode, stress induced bending. This mode is based on changes in surface stress of the cantilever as the target material binds to the sensing layer on cantilever. The target material may physically adsorb, dissolve into, or chemically bind to the sensing layer. Any of these methods of interaction can change the stress of the sensing layer and this stress change bends the cantilever up or down. By measuring the change in bend of the cantilever, one can estimate the amount of target material interacting with the sensing layer. The third method uses the bimetallic effect to detect heat evolved in chemical reactions. In this method the cantilever is coated with a relatively thick metal coating wherein, the sensing layer will either chemically react with the target substance or catalyze a reaction between the target substance and another material. The thick metal coating is chosen to have a different coefficient of thermal expansion from the material of the cantilever so that the assembly bends as the temperature changes. This bimetallic bending is used to detect temperature changes that occur when a target substance undergoes a chemical reaction on the cantilever surface.

All three of these methods have been used to detect the presence of various target substances which has led to several specific applications for cantilever sensors including recognition of specific biomolecules (for example antibodies and specific DNA sequences), detection of hazardous materials, and the use of cantilever sensor arrays as an “artificial nose” for aroma recognition.

Cantilever sensors have been used in commercial AFM heads, such as Digital Instruments' NanoScope MultiMode AFM head, to measure the motion of the cantilever within the AFM head. For example, the NanoScope Multimode AFM head applied an optical lever system wherein a light source, usually a laser, is focused and directed onto the end of a cantilever. The light reflected by the cantilever is sent to a position-sensing detector, usually a 2- or 4-segment photodiode or a lateral effect photodiode. As the cantilever bends in response to the target substance, the reflected light changes its position on the position-sensing detector. Standard signal processing electronics are used to convert the photodiode photocurrents into an electronic signal proportional to the deflection of the cantilever. For stress induced bending and bimetallic bending of cantilever sensors, this measurement of cantilever deflection is used to observe the presence of the target material. It is somewhat difficult in the prior work, however, to obtain an accurate calibration of the sensitivity of the detection method. The measured signal from the position sensing detectors depend critically on the spring constant of the cantilevers and the position of the laser on the cantilevers and the magnification of the optical lever system.

This technique has also been extended to arrays of cantilevers. Prior work has used an array of vertical cavity surface emitting lasers (VCSELs) to send individual laser beams to each of the cantilevers in a sensor array. Commercially available VCSEL arrays have individual lasers spaced at a pitch of 250 um. This technique works well, but usually requires a relatively large position sensitive detector or an array of detectors to capture all of the laser beams. The noise of the position sensitive detectors increase and the bandwidth decreases with increasing size. As a result the prior work had to accept somewhat higher noise and lower measurement rate (bandwidth) to accommodate the needs of measuring a cantilever array.

For the AC mass detection mode, it is necessary to measure the resonant frequency of the cantilever. The typical method for this is to measure the phase difference between the excitation signal used to oscillate the cantilever and the corresponding cantilever oscillation. Then a feedback loop is used to change the frequency of the excitation to keep the phase difference constant. When the phase difference between the excitation force and the cantilever is kept at 90 degrees, the cantilever will be operating at its resonant frequency. The cantilever array sensor system measures the changes in the excitation frequency required to keep the phase constant. From the change in resonant frequency, the amount of added mass of target material can be detected. One form of this technique is described for example in U.S. Pat. No. 6,041,642. This technique is limited by the accuracy of the feedback loop and the accuracy and speed with which the frequency can be measured. Some of the prior work discusses methods of determining the cantilever frequency by counting oscillation periods to determine the frequency. This method has the disadvantage that a large number of periods over an extended period of time must be counted to obtain an accurate measurement.

In the next section the fluid cells of the earlier work are discussed. Much of the work done previously has been performed in fluid cells of commercial AFMs, a typical example shown in U.S. Pat. RE 34,489 by Hansma et al. Other researchers have built custom flow through cells, for example the flow cell shown in the scientific poster “A micromechanical artificial NOSE” by M. K. Baller, et al. The flow cells typically consist of a transparent window that allows a laser beam or beams to pass into a sealed chamber. The flow cell also has an inlet and outlet port to allow gases or fluids to be directed to the cantilever sensors. The prior flow cells typically have inlet and outlet ports that are small compared to the cross-sectional area of the flow cell. This combined with the orientation of the inlet and outlet ports have led to large dead volumes of prior flow cells. These dead volumes are regions of the flow cell that are not easily exchanged by laminar flow through the flow cell. Molecules that get trapped in the dead volume of prior flow cells could remain in the flow cell despite substantial flushing of a new fluid through the flow cell. As a result, the molecules in the dead volume can contaminate future experiments as they diffuse out of the dead volume and into proximity of the cantilevers.

The prior flow cells also have a problem associated with the angle of the cantilevers are held with respect to the transparent window. Typically the laser beam is directed to strike the flow cell window at an angle that is substantially vertical. Then the cantilever is usually inclined at an angle, often around 10 degrees, so that the reflected beam will come out on a different trajectory that clears the optics associated with the incoming laser. This arrangement is shown in U.S. Pat. RE 34,489, for example. The problem with this arrangement is that the angle of the reflected laser beam that exits the flow cell window depends on the index of refraction of the material contained in the flow cell. There is a substantial shift in the outgoing angle as fluid is added to the flow through system and this shift is usually sufficient to require a mechanical readjustment of the position sensitive detector.

### SUMMARY OF THE INVENTION

The present invention provides an integrated cantilever sensor array system that accurately detects and measures the presence of target substances in various environmental conditions.

The integrated cantilever sensor array system comprises a cantilever sensor measurement head, a cantilever sensor system for measuring the oscillatory properties of the cantilevers and a measurement chamber.

More specifically, the measurement head includes a cantilever array having at least one cantilever, a light source and a detector positioned to detect incoming light reflected by the cantilevers within the cantilever array.

The cantilever sensor system measures the oscillatory properties generated by the cantilevers within the cantilever array. The system includes the cantilever array and a detection system that measures a signal related to the bending of the cantilever. In addition, optional components such as a high frequency clock, Q-Control, may be added to more accurately measure the oscillation of the cantilevers within the cantilever array.

The measurement chamber includes a flow cell and a cantilever sensor array mounted within the flow cell. The flow cell is designed to minimize dead volume and unwanted air bubbles within the cell, which may reduce accuracy of measurement. In addition, the flow cell has an inlet port and an outlet port regulated by a flow control valve, which allows target substances to flow into the flow cell and contact the cantilever sensor array. The flow control permits the system to function in a static and dynamic state. In addition, a temperature control device permits the regulation and manipulation of analyte temperatures.

The specific features and operation of the preferred and alternative embodiments of the invention will be explained in greater detail through the following drawings and detailed description.

### BRIEF DESCRIPTION OF THE DRAWINGS

Several embodiments of the present invention are illustrated in the accompanying drawings in which like reference numerals represent like parts throughout, and in which:

FIG. 1a illustrates a method of analyte detection known in the art as AC mass detection;

FIG. 1b illustrates a method of analyte detection known in the art as Stress-induced bending;

FIG. 1c illustrates a method of analyte detection known in the art as Heat-induced bending;

FIG. 2 is a simplified schematic cross-section diagram of the sensor array including a flow cell and measurement head of the preferred embodiment;

FIG. 3 illustrates an alternate embodiment of the sensor array including a laser detection head, a flow cell and a measurement head for spectroscopy;

FIG. 4 is a simplified system schematic for the preferred embodiment;

FIG. 5 is a simplified close-up perspective view of the assembled flow cell in the preferred embodiment;

FIG. 6 is a simplified exploded view of the preferred embodiment;

FIG. 7 is a simplified schematic block diagram of the Self Resonance circuit introduced in FIG. 4;

FIG. 8 is a simplified schematic diagram of the HF Gating Logic and HF Counter blocks shown initially in FIG. 4;

FIG. 9a is a simplified schematic diagram of a device and a method to change the effective quality factor Q of an oscillating cantilever to enhance the sensitivity of ac mass detection experiments;

FIG. 9b is a simplified schematic diagram for a method and a device for controlling and/or changing the Q of an oscillating cantilever for the purpose of more sensitive ac mass detection;

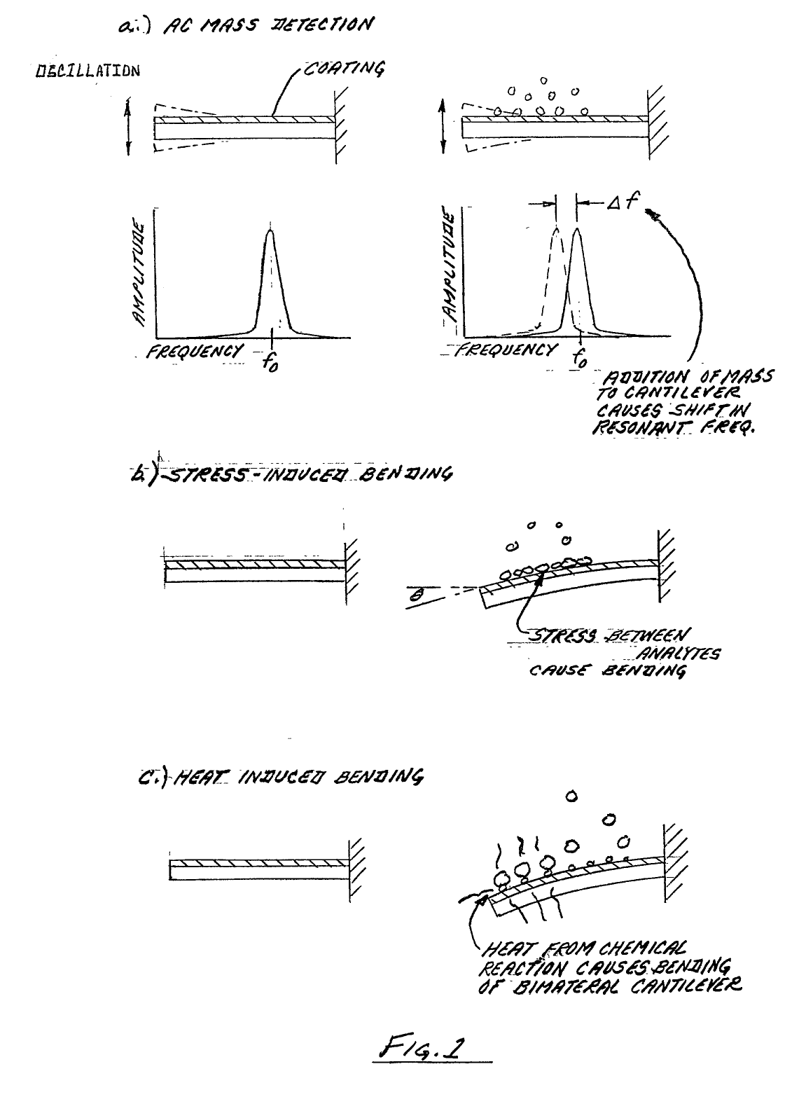

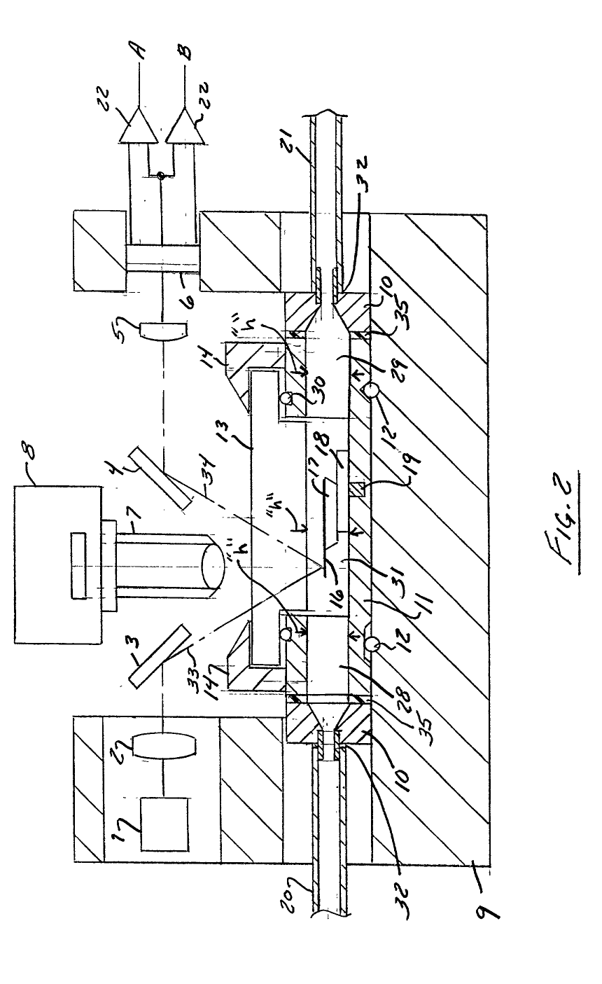

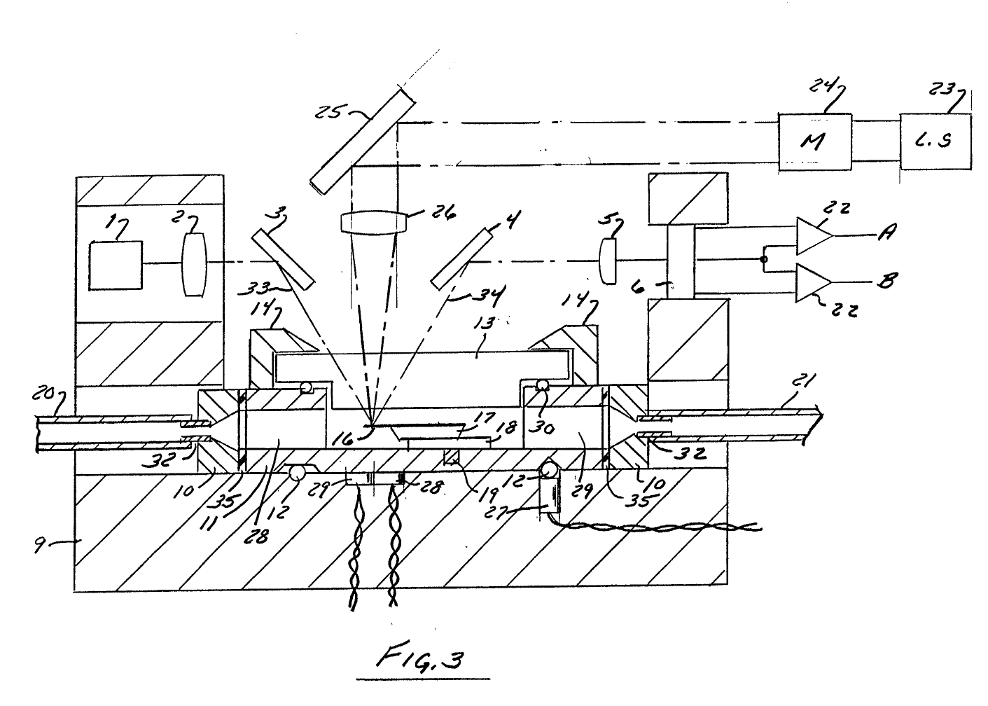

FIG. 1Oa-c illustrates the preferred device and method for measuring the amount of energy dissipation one or more cantilevers due to the presence of target substances;

FIG. 11 illustrates a simplified conceptual diagram for the measurement of phase lag by measurement of the time delay in an alternate embodiment;

FIG. 12 is a simplified conceptual drawing of a method and a device for measuring the energy dissipation of a material coated or deposited on a cantilever;

FIG. 13 is a simplified schematic diagram of a method and device for measuring the viscosity of a media surrounding an oscillating cantilever;

FIG. 14 illustrates an alternative embodiment where the cantilever is oriented with its wider dimensions perpendicular to the direction of oscillation;

FIG. 15 is a simplified schematic diagram of a feature of the measurement system where the angle of the reflected light beam(s) is independent of the index of refraction of the fluid;

FIG. 16 is a simplified schematic diagram of a method and a device to compensate for the change in light beam focus position upon introduction of liquid into the system;

FIG. 17a-c is a simplified schematic diagram of one embodiment of an optical measurement system used to measure the motion of the cantilever or cantilever array;

FIG. 18a-c is a schematic diagram showing the effect of placing a cylindrical lens in the path of the beams reflected from the cantilevers;

FIG. 19 is a simplified schematic diagram outlining three optional features of the preferred embodiment and one potential placement of a oscillation actuator used to oscillate the cantilevers for AC measurements;

FIG. 20 illustrates a tool and a method for exchanging the cantilever arrays; and

FIG. 21 illustrates a method and a device for allowing self-calibration of the cantilever sensor system.

### DETAILED DESCRIPTION OF THE PREFERRED EMBODIMENTS

The present invention is directed toward a cantilever sensor array system comprising an integrated cantilever sensor array system comprises a cantilever sensor measurement head, a cantilever sensor system for measuring the oscillatory properties of the cantilevers and a measurement chamber and optionally, a data acquisition and control system.

The measurement head includes a cantilever array having at least one cantilever, a light source and a detector positioned to detect incoming light reflected by the cantilevers within the cantilever array. The cantilever sensor system includes the cantilever array and a detection system that measures a signal related to the bending of the cantilever. The measurement chamber includes a flow cell and a cantilever sensor array mounted within the flow cell.

The cantilever sensor array is formed of at least one micromechanical cantilever sensor. The flow cell of the present invention allows material in a gaseous, fluid or vacuum environment to flow through the flow cell containing the cantilever sensor array in either a forward or reverse direction at any desired rate. Measurements can of course also be done in a static environment with no flow. The measurement head, or optical measurement head, detects and measures the motion of the cantilevers in the array by detecting and measuring the deflection of a cantilever caused by stress induced bending or heat induced bending as shown in FIGS. 1b and 1c, or by using AC mass detection to detect as a shift in resonant frequency as shown in FIG. 1a.

Signal conditioning electronics may be used to measure the deflection of the cantilever as a function of time. A data acquisition and control system may be used for a variety of tasks. For example it may be used to read the cantilever data, control the operation of the measurement head, control the operation of the flow system connected to the flow cell, control the measurement electronics, and control the temperature control system, if present in the system.

The cantilever sensor array system may also include additional optional components that will be discussed in greater detail in the following sections.

Referring now to FIG. 2, the preferred embodiment of the cantilever sensor array system comprises a flow cell 11, a cantilever sensor array 16 & 17 mounted with the flow cell and optical measurement head 9. The optical measurement head 9 utilizes an optical lever technique in which a light source 1, such as a diode laser or diode laser array, is focused using one or more lenses 2 onto the surface of at least one micromechanical cantilever 16 within the cantilever sensor array. The light source 1 may also be any other device that can produce a beam of light, including but not limited to a, vertical cavity surface emitting laser, a helium neon laser, an LED or infrared emitter, a superluminescent LED, and an incandescent source. The light source may produce a single beam or multiple beams. Each micromechanical cantilever 16, (hereafter cantilever) is micromachined out of silicon or similar semiconductor materials The cantilevers can be microfabricated onto a cantilever support structure or substrate 17. The cantilever array It is especially advantageous to have at least two cantilevers so that one can be used as a measurement cantilever and the other be used as a reference cantilever. More complex sensing experiments can be done with multiple cantilevers.

The cantilevers 16 have typical lengths from 1 um to several hundred microns. In some cases it is beneficial to have cantilevers with lengths of 1 to several mm. The widths of the cantilevers are usually smaller than the length for most applications, but can also range from 1 micron to several mm. For most sensing applications, it is advantageous to use cantilevers that are very thin in comparison to the length and width. Cantilevers with sufficient sensitivity can be made with cantilever thicknesses in the range of 1-10 microns. But some of the sensing modes become more and more sensitive as the cantilever thickness becomes smaller and smaller. For ultimate sensitivity it is desirable to fabricate cantilevers with thicknesses limited only by the practical limits of manufacturing technology and associated cost.

The optical measurement head of the present invention detects the motion of the cantilever by directing a light beam from light source 1 onto the cantilever 16, which then reflects the light beam to a detector 6. Mirrors 3 and 4, and lens system 5 will be discussed in more detail later. Detector 6 is a photodetecting device, preferably a lateral effect photodiode. It can also be a segmented photodiode like a bi-cell or quad-cell or it can be a CCD device or any other photodetector that can be used to determine the position of a light beam striking the detector surface.

In the preferred embodiment, detector 6 is a single axis lateral effect photodiode which generates two currents I₁ and I₂ that are related by the equation:

I₁=(PS/2)*(1+2Z/H)

I₂=(PS/2)*(1−2Z/H);

where H is the vertical size of the detector and Z is the vertical position at which the light beam hits the detector, as measured from the center of the detector.P is the optical power of the light beam, and S is the detector sensitivity.

From these two currents, the position of the light beam can be determined from the function

Z=(H/2)*(I₁−I₂)/(I₁−I₂).

Preamplifiers 22 are used to convert these photo-currents into voltages, shown as A and B. These are typically transimpedence amplifiers, but can be simple resistors or any other device that converts current into a voltage.

Detector 6 may also be a 2- or 4-segment photodiode or a single segment photodiode used in combination with a knife-edge or mask. Any of these techniques can be used to produce an electronic signal that is related to the motion of the cantilever array. Also note that the optical measurement system can be oriented in any direction without loss of function.

The cantilever sensor or sensor array 16 is usually fabricated on a solid substrate 17 made of silicon, glass or similar material. In the preferred embodiment of this invention, the substrate 17 is bonded to a mounting stub 18 that is made of an inert material, for example PEEK plastic, Teflon, or stainless steel. In the preferred embodiment, the mounting stub 18 is also magnetic or magnetizable, or contains a small piece of magnetic or magnetizable material. The stub 18 is typically held in place by one or more magnets 19 to the base of flow cell 11. The mounting stub 18 can also be held in place with an adhesive, a mechanical clamp or other means of attachment.

The flow cell 11 has inlet port 28 and outlet port 29 where fluid or gas can be introduced into the cell 11 and flushed out. The choice of inlet and outlet is arbitrary, although this design is biased to place the cantilevers closer to the inlet port for faster response times. The cell can also be operated in reverse. The flow cell 11 is sealed with a transparent window 13, an O-ring or gasket 30. The window 13 and O-ring 30 are held to the flow cell base 11 with a clamp 14.

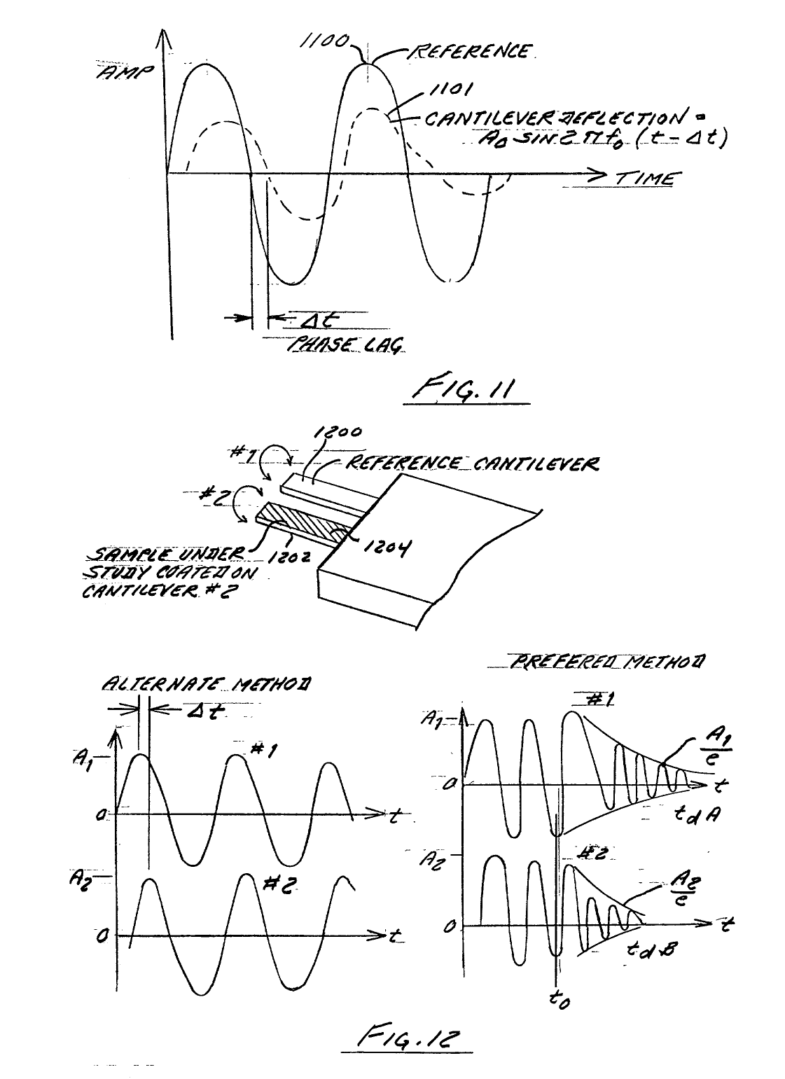

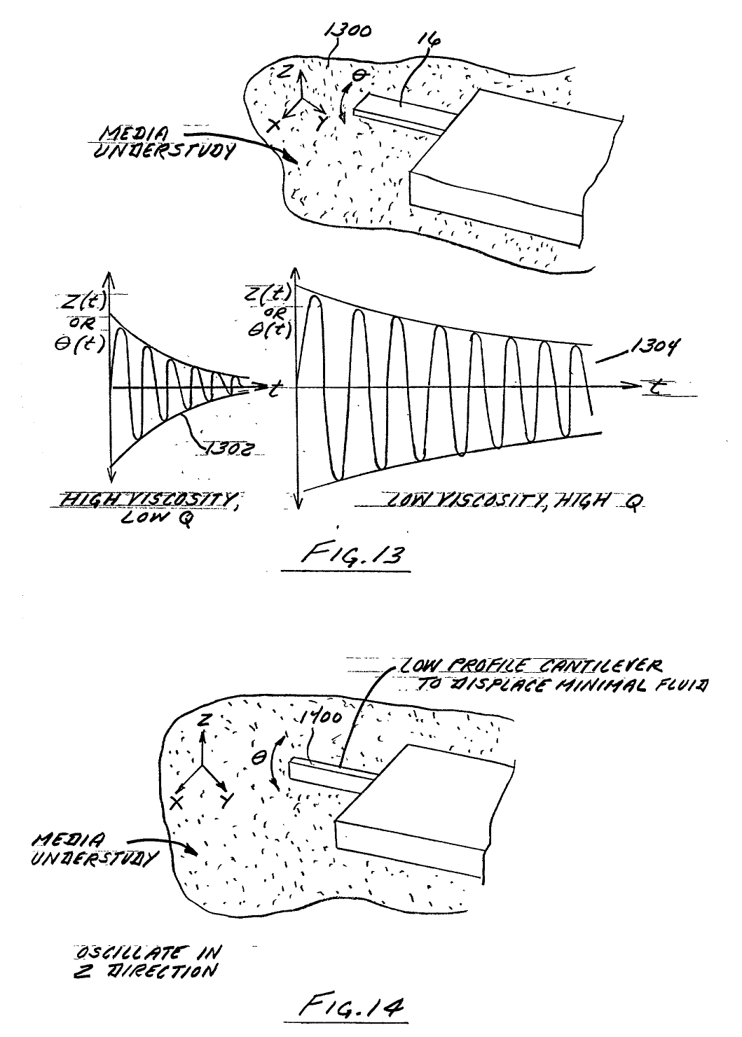

The flow cell 11 is designed to minimize dead volume, regions where the fluid is poorly circulated when the cell is flushed. One aspect of this design is to match the height of the bottom of the window 13 to the height of the top of the inlet 28 and outlet 29. Preferably, the height, “h” of the inlet 28, outlet 29 and the flow channel 31 are substantially equal. The width of the flow channel 31 is also matched to the width of the inlet and outlet, as shown in FIG. 6.

The flow cell 11 has optional end-caps 10 which taper the size of the inlet port 28 and outlet port 29 from the size matching the flow cell 11 to a size matching a convenient hose fitting. This is shown in schematically in cross-section in FIG. 2 and in perspective in FIG. 6. Inlet hose 20 and outlet hose 21 are typically installed on the hose fittings 32 and these hoses are connected to a mass flow system described later. In an alternative embodiment the flow cell 11 can be open to the environment for environmental sampling or sealed for static measurements.

Optional mirrors 3 and 4 have several uses. First, they allow the detection incident and reflected light beams to be arranged in a way that provides optical and physical access from the top of the flow cell 11. Second, mirror 3 can be shaped in a way to reduce optical aberrations introduced by light beam 33 traveling through window 13 at a non-orthogonal angle. As light beam 33 transverses the window 13 an optical aberration called coma is introduced. This aberration can be largely reduced or eliminated by adding some concave curvature to the reflective surface of mirror 3. For example, the inventors used the optical design program Zemax from Focus Software, Inc, to determine the size of the focused spot for different curvatures of mirror 3 for the cantilever sensor measurement head shown in FIG. 2. If mirror 3 is a flat mirror, the focused spot may have a geometric radius of roughly 56 um. If however, a slight concave curvature is added, for example −1.5 m in the case of our design, the focused spot size can be reduced to a geometric radius of roughly 5 um. The ideal curvature of this mirror 3 depend on many parameters, for example the angle of incidence of the incoming light beam 33, the choice of focusing lenses, the optical properties of the window, but in many cases a substantial improvement in spot size can be achieved by adding curvature to the mirror.

Mirror 3 can also be used to make coarse adjustments in the laser position, for example, to compensate for different cantilever lengths or positions. Mirror 4 may be used to steer the reflected laser beam 34 onto the center of the position sensitive detector 6.

In the preferred embodiment, a microscope objective 7 and camera 8 are arranged to provide a view of the cantilever array 16 and flow cell 11. In addition, the mirrors 3 and 4 can be adjustable and be used to steer the incident light beam onto the cantilever array 16 and the reflected beam onto the detector 6.

In the preferred embodiment the light source 1 is an array of multiple laser diodes which facilitates the measurement of an array of cantilever sensors 16. The light source 1 can also be a single source for lower cost/simpler systems. The light source 1 can be an array of discrete laser diodes, an array of Vertical Cavity Surface Emitting Lasers (VCSEL), an array of optical fibers coupled to one or more remote light sources, an array of light emitting diodes, or any other device or devices that produce light beams that can be directed to the cantilever array. The light source 1 could also produce a single extended beam (like a ribbon laser). In this case, the detector 6 is preferably replaced with an array of multiple detectors or an aperture system or other discriminating means that can select out the light beam reflected from a single cantilever. In the aperture system, for example, an array of apertures could be arranged so that only one is opened at a time, letting through the reflected beam from one cantilever. Alternatively, a single aperture could be translated to correspond to the position of the reflected beam from the cantilever of interest. Fabricating cantilevers within a cantilever array such that each cantilever has a different resonant frequency is also useful. In this way, it is also possible to use a single extended light beam and a single detector for AC measurements, where the motion of each cantilever is determined by selecting the frequency component for each cantilever.

Referring now to FIG. 3, the cantilever sensor array system alternatively comprises an alternative optical measurement head such as a spectroscopy system.

The spectroscopy system shown in FIG. 3 includes a second light source 23, which has a wide or adjustable spectral distribution, a monochromator (or bandpass filter) 24, a reflecting mirror 25, and a focusing lens 26. In this embodiment, the wavelength of incident light can be adjusted by changing the light source and/or the monochromator passband. With this arrangement, spectroscopic studies can be performed on small samples coated on or attached to one or more of the cantilevers on the cantilever array. The light source 23 can also be a narrow band coherent source, like a laser, and can be used to excite specific absorptions in the material under study.

FIG. 3 also shows three optional components of the preferred embodiment, an oscillation transducer 27, a heater/cooler 28 and a temperature measuring device 29. The oscillation transducer 27 is typically a piezoelectric device where an applied voltage generates a corresponding motion. In the preferred embodiment, this oscillation transducer 27 is a piezoelectric stack, bimorph or simply a piece of a piezoelectric crystal. The oscillation transducer 27 could also be an electrostrictive, electrostatic, or magnetostrictive device, a voice coil, or any other device that produces a motion in response to an applied signal. The oscillation transducer 27 is used to oscillate the cantilevers for AC measurements, like those shown in FIG. 1a, and others to be described later. This oscillation transducer 27 and discussion of its placement are described in more detail in FIG. 19 and associated text.

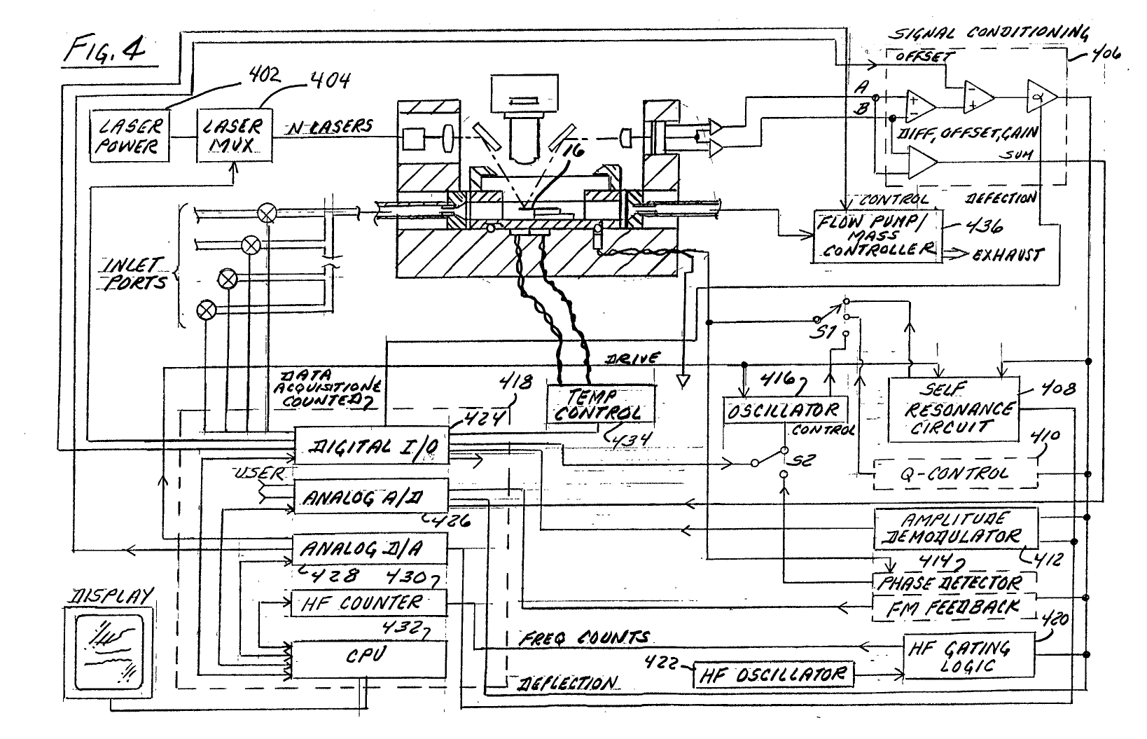

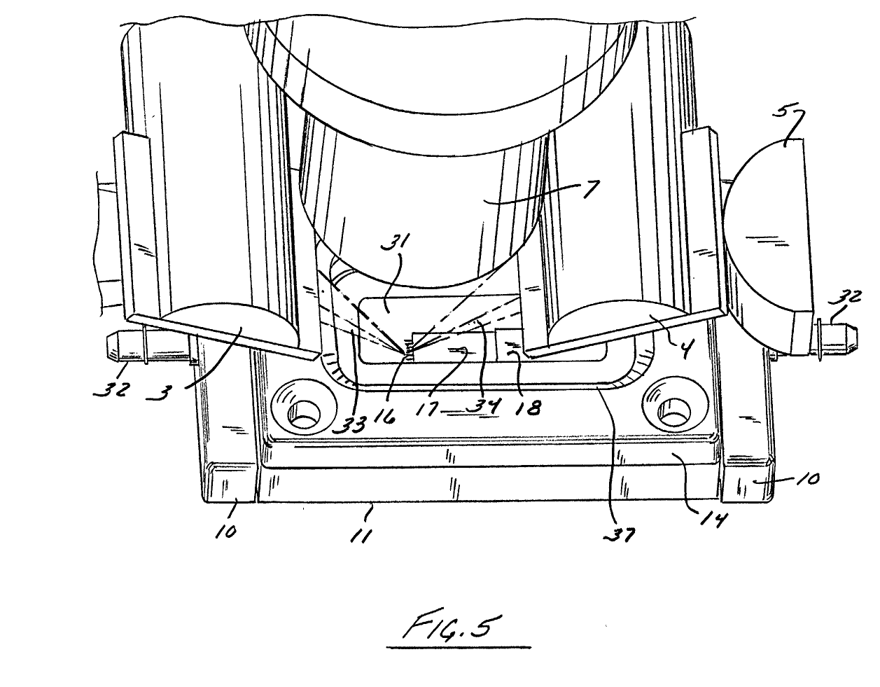

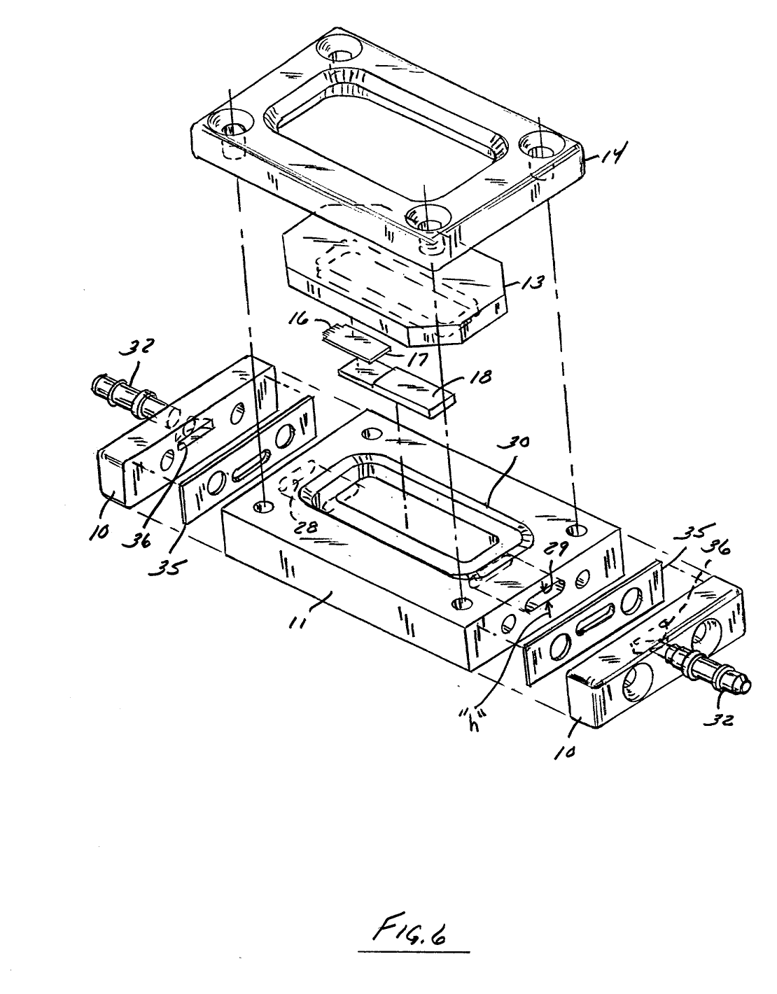

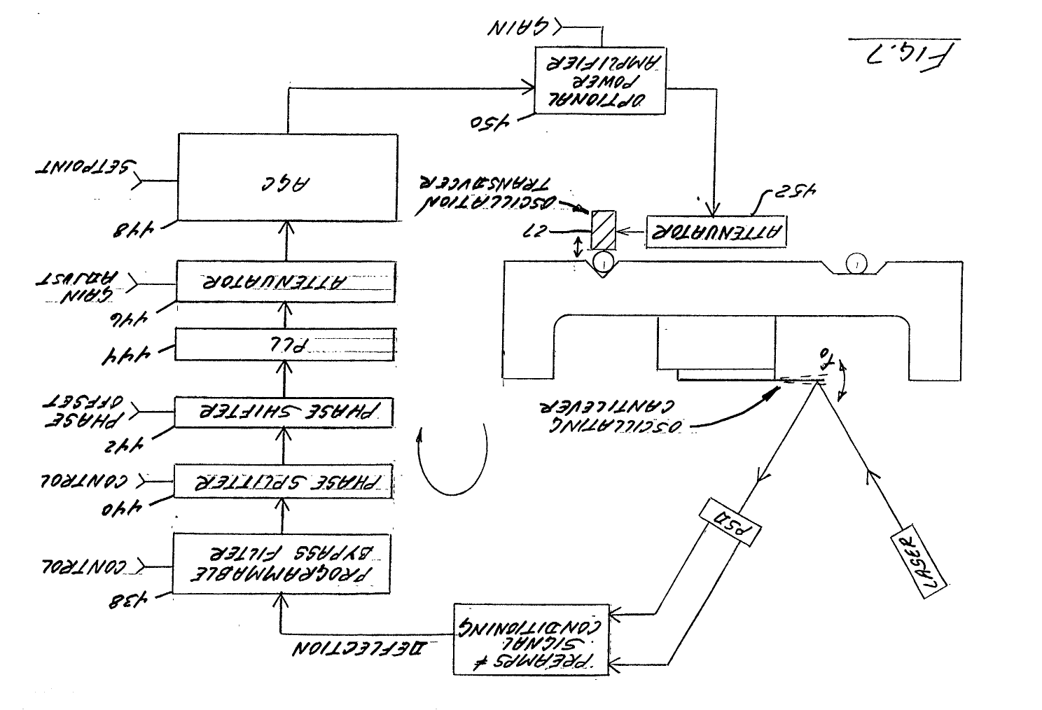

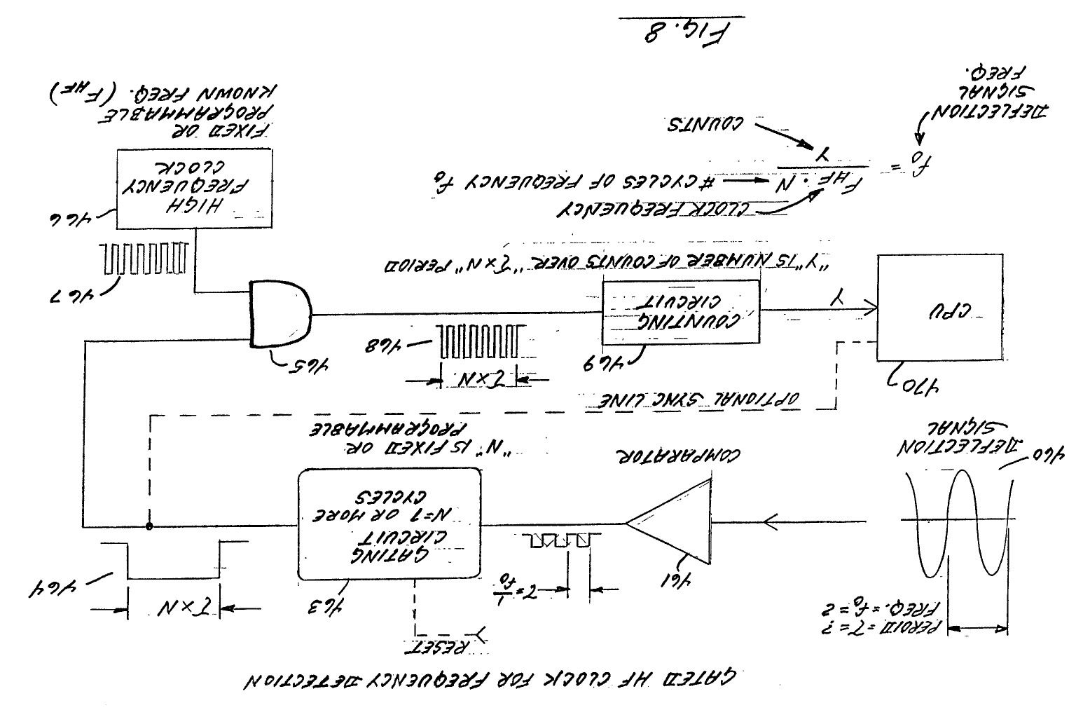

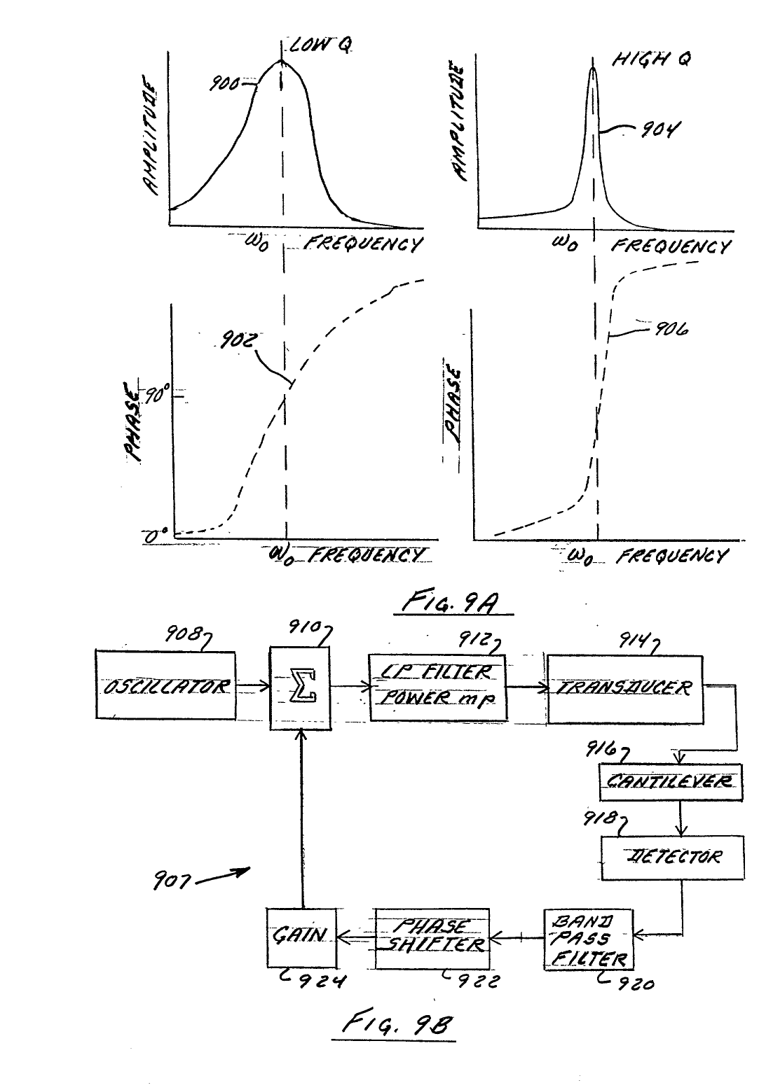

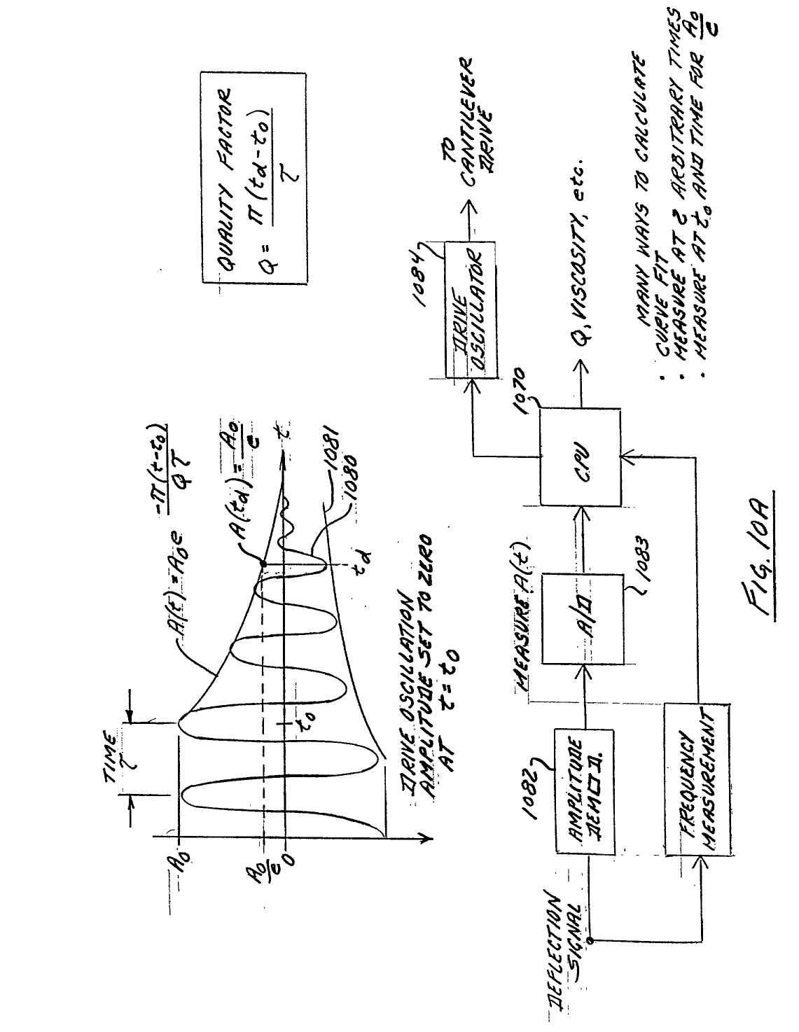

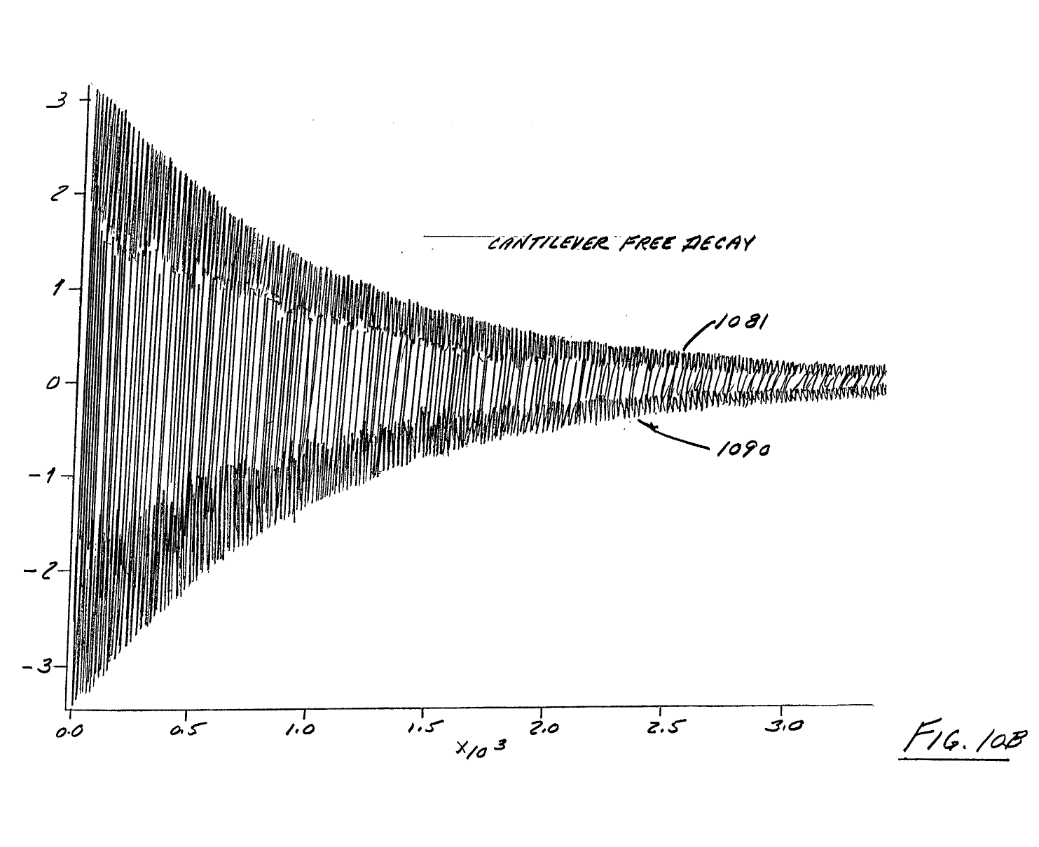

Referring now to FIG. 4, the flow cell 11 and measurement head 9 discussed in relation to FIGS. 2 and 3 are shown in the center. The flow cell 11 is surrounded by a series of blocks, corresponding to other subsystems of the design.

It is often desirable to control and/or change the temperature for scientific experiments or for special purpose sensors. This device provides optional means to control and/or change the temperature of the cantilever array and any gas, vapor, or fluid sample entering the flow cell. This is shown schematically in FIG. 4 and will be shown in more detail in FIG. 19 and associated text.

Because the system can support multiple cantilever sensors, a laser multiplexer (Laser MUX) 404 is used to select which laser will be powered by the laser power supply (Laser Power) 402. When the detector 6 generates a signal, detector voltages A and B are sent to signal conditioning electronics 406 that usually contain three main components, differential measurement, offset, and gain. The differential measurement typically generates a signal that is proportional to A−B or A−B/(A+B). The offset circuit is used to remove offset and center the circuit before the gain stage. The gain stage, often adjustable, allows the cantilever deflection signal to be amplified so that it is at an optimal level for data acquisition and other electronics. These three stages can be done in hardware with electronic circuits or any one or all can be performed in a computer or microcontroller. Highpass filters, low pass filters or bandpass filters are also often used in the signal conditioning electronics to reduce the noise of the signals of interest.

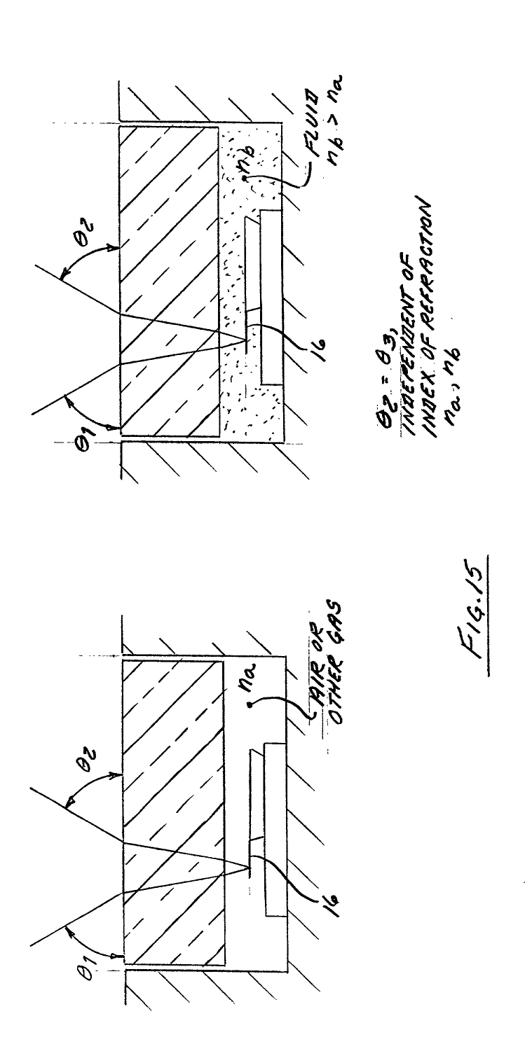

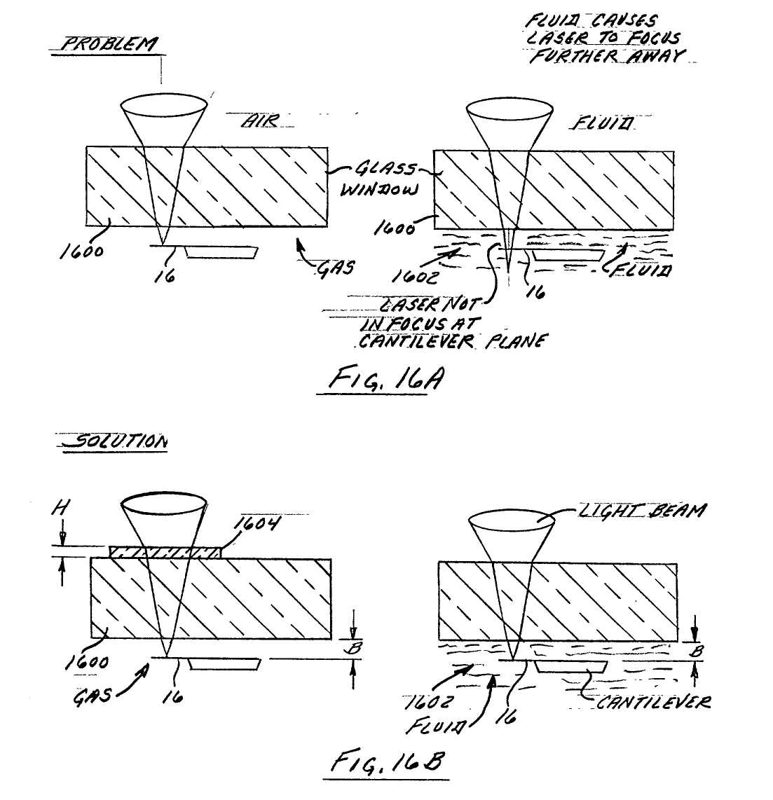

The output of the signal conditioning electronics is for the most part proportional to the angular deflection of the cantilever under study. This signal will be referred to as the “deflection signal” or “cantilever deflection.” The deflection signal is then sent to several locations in the preferred embodiment. One place it is sent is a Self Resonant Circuit 408. This circuit includes a feedback loop and an automatic gain control system that works in combination with the previously mentioned oscillation transducer to oscillate the cantilevers in the cantilever array at their mechanical resonant frequency. This is shown in more detail in FIG. 7 and will be described more fully later.

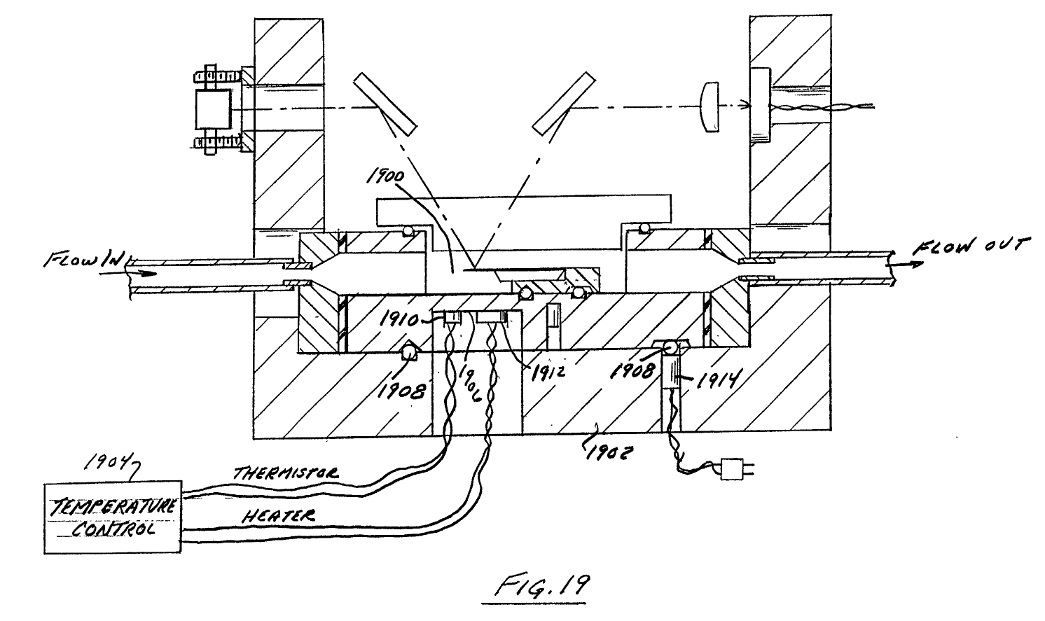

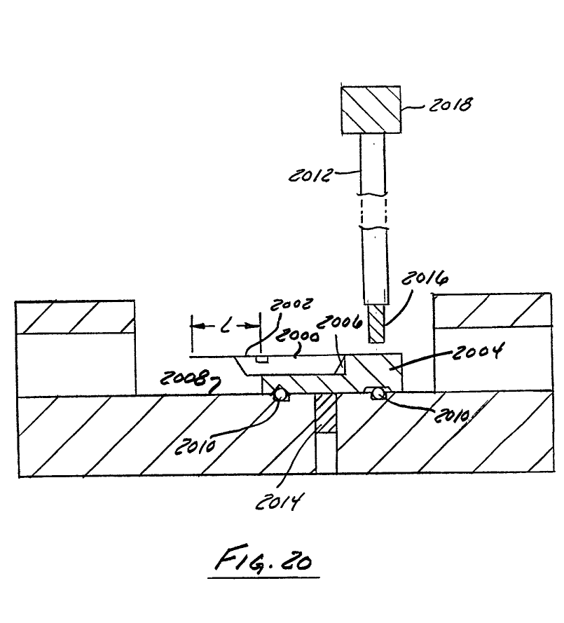

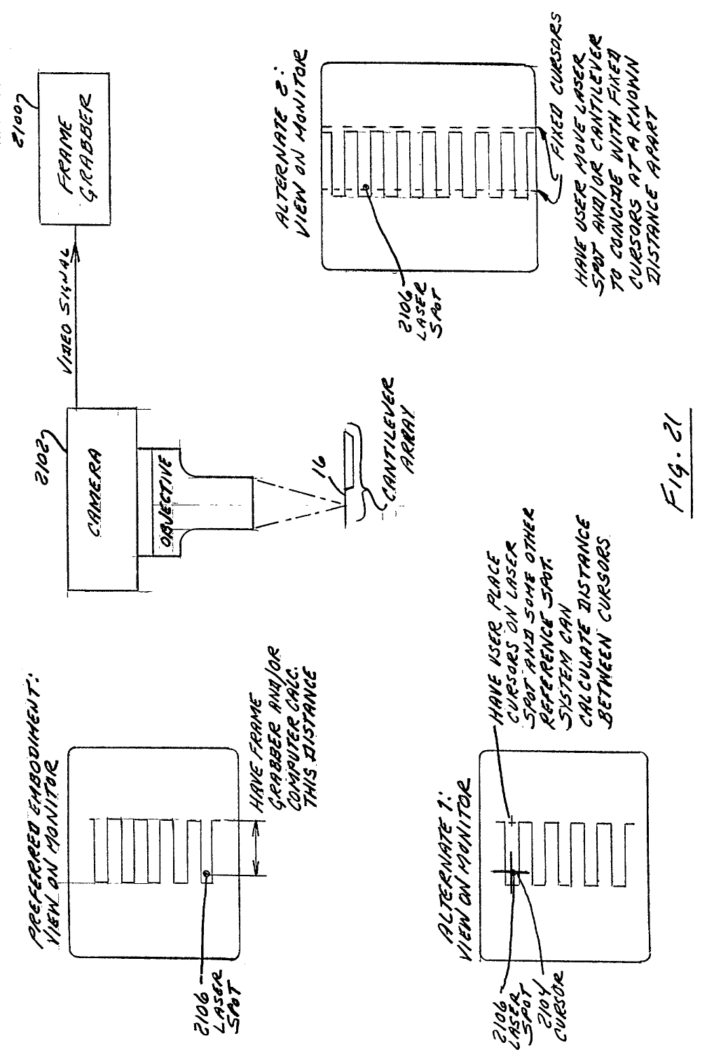

Below the Self Resonance Circuit 408 is an optional subsystem called “Q-control” 410. This is a circuit that is used to adjust the apparent quality factor Q of the oscillating cantilever by applying oscillating forces to the cantilever. The quality factor can be an important parameter for AC cantilever measurements as it affects both the response time and the sensitivity of the cantilever. The Q-control circuit 410 allows the user of the device to optimize the measurement for the timing and sensitivity required. This is shown in more detail in FIG. 9 and also described in more detail later.

Below Q-Control is Amplitude Demodulator 412. This is a circuit that converts the cantilever deflection into a measurement of the oscillation amplitude. The Amplitude Demodulator can be a lock-in amplifier, a RMS-to-DC converter, a peak detection circuit, or any other device or method for determining the amplitude of oscillation of the cantilever. These devices are well known to those skilled in the art and will not be described further.

Next is the optional Phase Detector/FM feedback module 414. This module outputs a signal that is proportional to the phase lag between the cantilever deflection signal and the oscillation signal sent to the oscillation transducer. The phase lag of an oscillating cantilever is a measure of dissipation and is related to several interesting physical processes that can be studied with microcantilevers. These measurements are shown in more detail in FIG. 11-14 and associated text. The phase signal can be generated in a number of ways, for example by lock-in amplifiers, analog circuits with discrete components, phase comparator integrated circuits, digital signal processors and microcontrollers. These techniques are well-developed and will not be discussed in more detail. Any device that produces a signal or data that is related to the phase lag can be used in this function.

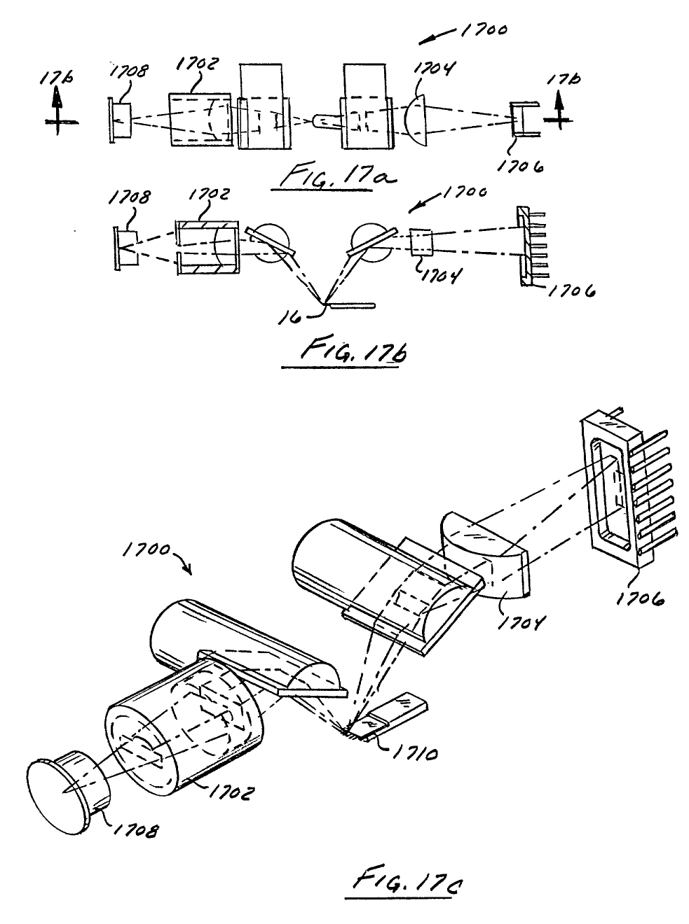

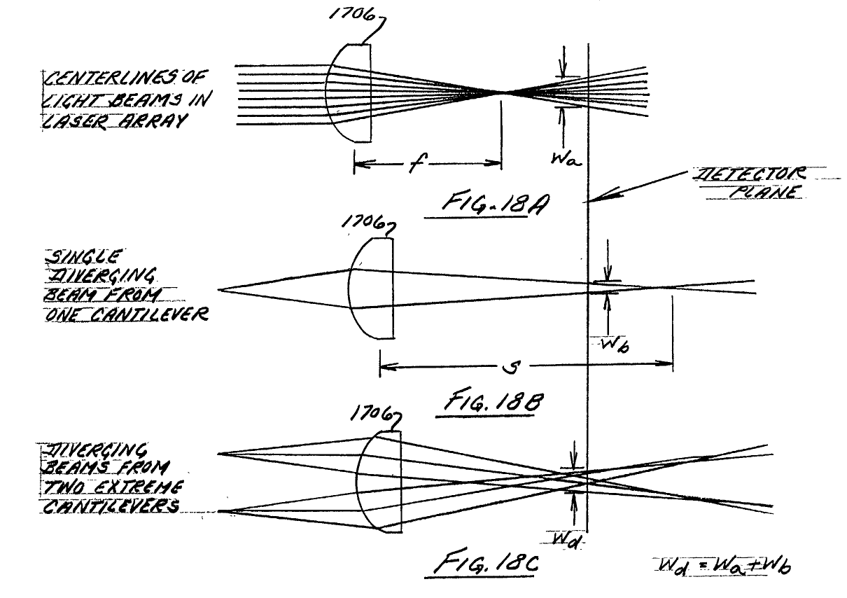

The Phase Detector/FM feedback module 414 can also be used as part of a self-resonant circuit. In this mode, the phase signal from the phase detector is used as a feedback signal. A feedback loop is used to adjust the oscillation frequency to keep the phase at a constant value. If the dissipation is constant, maintaining the phase at a constant value will also keep the cantilever oscillating at its resonant frequency. (The dissipation may well be not constant, and this leads to improved methods of determining the resonant frequency and phase in FIGS. 8 and 10.) The feedback loop in the Phase Detector/FM feedback module 414 is digital, that is the phase signal is sent to a microcontroller which calculates an oscillation frequency based on the phase shift and the gain parameters programmed into the microcontroller. The output of the microcontroller is used to program a digital frequency synthesizer, shown as the Oscillator 416 in FIG. 4. In other embodiments, the oscillator can be a voltage-controlled oscillator (VCO) and the FM feedback loop can be based on analog circuitry. The Phase Detector/FM Feedback loop may be built into the same electronics assembly but each component could be implemented separately, or not at all.

Note that there are two optional switches, SI and S2 above and below the Oscillator 416, respectively. Switch S1 is a two or three pole switch that determines whether the oscillation transducer is driven by the Self-Resonance circuit 408, the Q-Control circuit 410, or driven by the Oscillator 416 which is controlled externally by the Data Acquisition and Control module 418. Switch S2 enables or disables the optional frequency feedback loop in the FM Feedback module 414. Switches S1 and S2 can be manual switches or preferably computer controlled. The switches can also be eliminated if the optional components they enable are not included in the system.

In the preferred embodiment the system is operated in self-resonance mode as shown in more detail in FIG. 7. The oscillation frequency can then be measured as a function of time to determine the effects of substances bound to the cantilever or as a function of changing environmental conditions. This invention contains an extremely sensitive and accurate resonance frequency detector. The first part of this detection system is a high frequency gating logic circuit, labeled “HF Gating Logic” 420 in the lower right of FIG. 4. This circuit opens a switch to allow a high frequency and high accuracy clock signal (the “HF Oscillator” block 422) to pass through for a time corresponding to an integer number of periods of the cantilever oscillation frequency. The number of counts of the HF oscillator 422 can be counted accurately by commercially available counters as shown in the Data Acquisition and Control Module 418. This technique provides very high accuracy frequency measurements in a relatively short time.

The Data Acquisition and Control Module 418 serves the functions of controlling the operation of the various subsystems and sampling all external data of interest. The Data Acquisition and Control Module 418 consists of the following capabilities which may reside on one or multiple circuit boards: Digital I/O 424, Analog A/D 426, Analog D/A 428, the previously mentioned HF counter 430, and a CPU 432 and associated support hardware (not shown). In versions of the device with limited capabilities, some of these components may not be required.

We will now describe the various functions of the Data Acquisition and Control Module 418 in the preferred embodiment. The Digital I/O block 424 is used to control various external devices and system parameters. It can consist of both serial and parallel digital communication. For example, it may be used to program the desired temperature of the Temperature Controller 434. It can also be used to program the desired flow rates of the Flow Pump/Mass Controller 436. (Both of these units could also be controlled by analog voltages or currents.) The Digital I/O block 424 can be used to actuate one or more switches like S1 and S2 which enable and disable optional components or functions. It can also be used to communicate digital data to and from the CPU 432 and to and from other devices and circuits. The Digital I/O block 424 can also be used to control the gain of the Signal Conditioning Block 406, the Self Resonant Circuit 408, the Oscillator 416 frequency and/or amplitude, the phase offset of the Phase Detector 414, Amplitude Demodulator 412 and/or Self Resonance Circuit 408. The Digital I/O block 424 is also used to control the Laser MUX 404 to activate and deactivate the lasers of choice.

The Analog A/D block 426 consists of one or more analog to digital converters. These are used to read the various data channels generated by the measurement head into the computer. Some of these inputs are shown schematically in FIG. 4. For example the system can read the deflection signal, the cantilever amplitude, phase, and frequency. The signal labeled as “Sum” is also a useful signal. It is proportional to the total amount of light reflected off the cantilever. This signal is useful for aligning the lasers onto the cantilevers and can be used to normalize the deflection and amplitude signals. The system can also read any auxiliary inputs that a user might want to add. For example a user might want to import a pH signal or an electrochemical potential, or the input of an auxiliary photodiode.

The Analog D/A block 428 converts digital signals from the CPU 432 into analog control voltages for the system. Some examples include the desired oscillation amplitude which can be sent to the Oscillator 416 and/or Self Resonance circuit 408. The Analog D/A block 428 also sends an offset voltage to the Signal Conditioning block which 406 is added or subtracted from the cantilever deflection signal before amplification. The Analog D/A block 428 can also be used to control the gain of any variable gain amplifier or attenuator, and can be used to adjust the bandwidth of variable filters. These controls could also be handled by the Digital I/O block 424.

The HF Counter block 430 is a high speed pulse counter. It is used to measure the cantilever oscillation frequency in a method to be described later.

The CPU 432 performs functions including computation, control, communication, interface to storage devices and display devices. The CPU 432 may be any type of computational device, for example, a personal computer, a palm computer, a microprocessor, a microcontroller, a digital signal processor, or any combination of these. The CPU 432 provides interface to the user, control over the experimental parameters, control over the data acquisition and storage and display of the experimental results.

Each of the blocks in the Data Acquisition and Control module 418 can be purchased as commercial or can be custom built to have the specific features required.

The Flow Pump/Mass Controller 436 consists of any number of commercially available or custom made devices for inducing the flow of gases and liquids. For example such devices as syringe pumps, diaphragm pumps, peristaltic pumps, gravity feed devices, rotary pumps, vacuum devices, micromechanical pumps, pressurized gas, etc can be used to induce flow into the system. The pump can also be omitted to allow potential samples to simply diffuse or flow by convection into the measurement chamber.

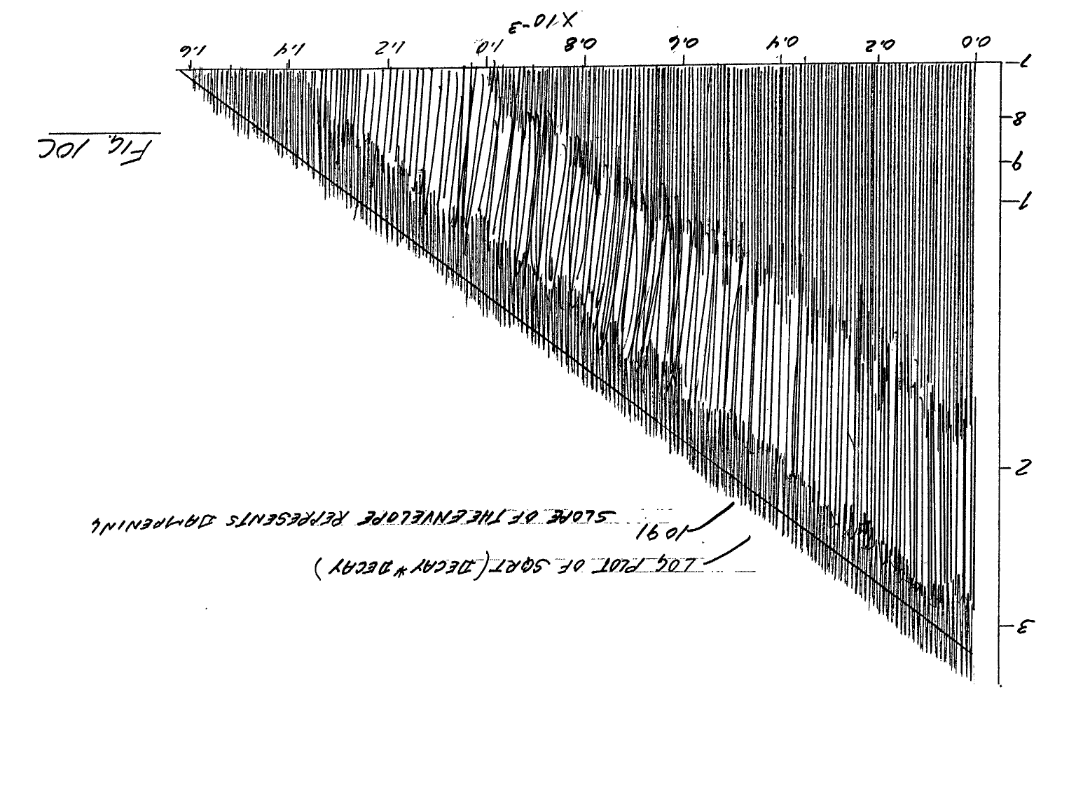

FIG. 5 shows a simplified close-up perspective view of the assembled flow cell in the preferred embodiment. FIG. 6 shows a simplified exploded view of the same assembly. In FIG. 5, an array of cantilevers 16 attached to cantilever substrate 17 is shown. The cantilever substrate is bonded or attached to mounting stub 18. The mounting stub preferably has an alignment edge to help align the back of the cantilever substrate during assembly. In an alternative embodiment, the stub 18 may also have a mechanical spring clip to hold the cantilever substrate 17 without use of adhesives or other bonding.

A single incoming laser beam 33 and single outgoing laser beam 34 are shown. The Laser MUX shown in FIG. 4 selects which laser or lasers are activated. The microscope objective 7 is shown viewing the cantilever array, laser beams and other contents of the flow cell. The flow base 11 is typically made of an inert material that can withstand the exposure to various fluids and gases and can be easily cleaned. Common material choices are stainless steel, glass, and various inert plastics like Teflon, polypropylene, PEEK, to name a few. A window 13 (seen more easily in FIG. 6) is used to close the top of the cell and provide optical access for the measurement head and the optical microscope. The ends of the flow cell are sealed with endcaps 10 and gaskets 35 (FIG. 6), O-rings or other sealing devices. Inlet and outlet hose adapters 32 provide easy coupling to gas and fluid lines. To minimize dead volume, the endcaps are preferably formed with a tapered cavity that expands from the size of the inlet and outlet hose adapters to the size of the flow channel 28. This tapered cavity need not be present if dead volume is not a major concern for the measurements being performed.

The window clamp 14 holds the window in place and seals the window against an O-ring 30, gasket or other sealing device. The top clamp 14 can be attached to the flow cell base 11 with screws (not shown), clips, gravity, magnets or any other method or device that provides sufficient force to seal the flow cell.

The flow cell can also be constructed in many other ways with the same basic function. For example, the flow cell base could be molded, cast or machined from a single block. Also, the window clamp 14 and the window 13 could be made out of a single piece. The dimensions of the cell can be altered for absolute minimum size or for larger cells with more convenient access. Any number of additional fluid inlet and outlet lines can be included, along with ports for electrodes and sensors for properties like temperature, pH, pressure, flow rate, etc. It is possible to add the capability to ionize incoming target substances through the use of electron beams, X-rays, ultraviolet light. It is possible to add electric and magnetic fields to shape and/or direct the flow of ionized substances. The flow cell need not be rectangular in shape.

FIG. 7 shows a simplified schematic block diagram of the Self Resonance circuit 408 introduced in FIG. 4. This circuit consists of a feedback loop connecting the cantilever deflection signal and the oscillation transducer. When the overall gain of the circuit exceeds one at an appropriate phase shift, the circuit will go into spontaneous self oscillation at the frequency of the highest Q (quality factor) resonance. In most cases, the highest Q resonance will be the mechanical resonance of the cantilever sensor. (Care must be taken in the design of the system mechanical and electrical components to ensure this is the case.) Typical values for the cantilever Q in air are on the order of 10-1000. In vacuum this Q value can exceed 100,000. In liquid the Q may drop to 10 or below making the self-resonance operation more challenging.

The Self Resonance circuit 408 works in the following way. As the system is switched on AGC detected that the signal, which is noise at this point, is well below the setpoint ( a preset amplitude), The gain of AGC will increase so that the total gain in the loop is larger than one, yielding a positive feedback. The noise band at the cantilever resonance frequency is subjected to Q time higher mechanical amplification each time the signal goes around the loop. As a result the system develops signal most efficiently at the resonance frequency . AGC will reduce gain to 1 as the resonance signal amplitude approaches the setpoint and remain steady. The time scale to develop a well defined cantilever resonance is in the order of milliseconds, meeting speed requirement of most chemical sensing applications. As cantilever deflection signal is generated the signal then goes to a “Programmable Bandpass Filter” 438 in FIG. 7. This filter generally passes a fairly wide band of frequencies, but is usually used to select which oscillation mode of the cantilever to excite. In the case of using the fundamental bending mode at frequency f₀, a second bending mode can also be driven into oscillation at roughly 6.2 times f₀. The Programmable Bandpass Filter 438 ensures that only the desired oscillation mode is passed through the filter. In the case that the fundamental mode is selected, the Bandpass Filter 438 will allow the fundamental frequency through the filter but exclude the higher frequency mode. The Bandpass Filter 438 may be as simple as a fixed frequency low pass filter, but it is advantageous to allow this filter block to be programmable to accommodate different cantilevers with a range of resonant frequencies.

For the Self Resonance circuit 408 to operate correctly, the system must maintain a roughly a 90° phase shift between the oscillation transducer and the oscillating cantilever. At this phase relationship, the energy from the oscillation transducer is most efficiently coupled into the system and the cantilever will oscillate at resonance. This phase control is maintained by either an adjustable phase offset or a phase offset controlled by a phase locked loop. The preferred embodiment contains a coarse phase adjustment (442 and 443) followed by an automatic phase lock loop, PLL 444. The coarse phase adjustment in the preferred embodiment contains both a phase shifter 440 and a phase splitter (inverter) 442 to increase the dynamic range of the phase offset.

Once the phase is coarsely adjusted within the operating range of the PLL 444, the PLL automatically maintains the desired resonance phase relationship. Phase lock loops are also well known and will not be described further. The coarse phase adjustment may be done manually by a user or automatically under computer control. When done automatically, the phase offset is adjusted under computer control while the cantilever amplitude is monitored. Since the self-resonance circuit will not oscillate if the phase is adjusted incorrectly, sweeping the phase can optimize the phase offset and setting it to the point that generates the largest oscillation.

Next is an optional variable gain stage, more often referred to as an Attenuator 446 as shown. The next stage, the Automatic Gain Control block (AGC) 448 typically has very large gain. The Attenuator 446 reduces the amplitude of the incoming signal so that the output of the AGC 448 is not saturated. In the preferred embodiment the gain of the Attenuator is adjustable under external control to accept a wide variety of cantilevers.

The AGC 448 consists of a variable gain stage where the gain is dynamically and automatically updated to maintain the system gain around 1, keeping the system in steady self-oscillation. The AGC 448 has an input that sets the desired oscillation amplitude setpoint. The gain of the AGC 448 is reduced if the amplitude exceeds the setpoint value and is increased if the amplitude is below the setpoint value. The AGC capability can be implemented in analog electronics, digital electronics, a computer, microcontroller, or a combination of the above. The details of AGC circuits and algorithms are well known and will not be described here.

The next block is an optional power amplifier 450. In the case that the oscillation transducer 27 is a high-current device, a power amplifier may be required to drive the device. For small oscillation amplitudes and for systems where the motion of the transducer is well coupled to the motion of the cantilever, this may not be required.

Next the signal may be sent to a second optional attenuator 48. This attenuator block 452 is important for optimal performance of the system because it is desirable to match the signal strength of the cantilever deflection signal and the oscillation drive signal from 448 to transducer 27. If the signals are well matched, cross-talk between these signals is not a problem. If the deflection signal is much larger than the oscillation signal, the deflection signal may generate cross-talk onto the oscillation signal line. In this case the amount of cross-talk will not be controlled by the AGC 448, the phase will not be controlled by the PLL 444, and the self-resonance circuit 408 may not operate correctly. The Attenuator device 452 is placed very close to the oscillation transducer to allow the oscillation signal and the deflection signal to have similar magnitudes for most of the signal path.

FIG. 8 shows a simplified schematic diagram of the HF Gating Logic 420 and HF Counter 430 blocks shown initially in FIG. 4. Starting in the upper left comer, the cantilever deflection signal 460 is typically sent to a comparator 461 or equivalent device or circuit which turns the sine wave input 460 into a square wave 462. (This circuit will also work without the comparator.) Next the square wave is sent to a Gating Circuit 463. The Gating Circuit may be most conveniently programmed into a programmable logic device, for example a CPLD (Complex Programmable Logic Device), but can also be built from discrete logic components or any other device that allows high speed digital computations to be performed. The gating algorithm could also be built into a microcontroller or computer with accompanying software.

The Gating Circuit is designed or programmed so that it changes state (from high to low, for example) during a period of time corresponding to an integer number (N) of oscillation cycles of the input signal. In the preferred embodiment the number of oscillation cycles N is programmable for greatest flexibility over speed and resolution. The number of gating cycles can of course also be fixed. The output of the Gating Circuit will be a pulse 464 that has a time duration corresponding to N×τ where τ is the time period of the cantilever oscillation frequency. This pulse is used to gate in a high frequency, high accuracy clock signal 467 from clock 466 which will provide high resolution for counting the oscillation frequency. This gating can be accomplished by sending the gating pulse to an AND gate 465 which sets the output high only when the gating pulse is high and the clock signal is high. The result is series of clock pulses 468 over the gated pulse period of time N×τ. The pulses are then counted by a high speed Counting Circuit 469 and the number of counts Y are sent to the CPU 470 or other data device for data acquisition, storage and/or display. The cantilever frequency can be calculated from the formula f₀=N*F_{HF}/Y, where F_{HF} is the oscillation frequency of the High Frequency Clock 466. To determine the number of counts Y, the Counting Circuit 468 can count oscillation cycles, peaks, and/or zero crossings. If the HF Clock 466 outputs a sinusoidal signal, an additional comparator may be used to convert it into a square wave for more accurate counting of cycles.

The resolution and accuracy of this counting scheme is limited by the accuracy and frequency of the High Frequency Clock 466 and the sampling time. For a highly accurate clock, the resolution is determined by the uncertainty in the number of counts (usually one HF Clock count), the Clock frequency and the sampling time. The minimum detectable frequency change Δf is given by the equation Δf=f₀/(F_{HF}Δt), where f₀ is the cantilever resonant frequency and FHF is the oscillation frequency of the High Frequency Clock 466, and Δt is the approximate sampling time. (Note that the sampling time is not fixed, but is a function of the unknown cantilever resonant frequency.) As an example, for a resonant frequency of 100 kHz, 50 msec sample time and a 15 MHz HF Clock frequency, the frequency resolution of 0.13 Hz.

The preferred embodiment of the Gated HF Logic 420 may also include an optional reset line to restart the Gating Circuit 463 to allow a new pulse through. (This reset line may be manually actuated, actuated by computer, or at a fixed period.) This counting system can also include an optional sync line that lets the CPU 470 know when the frequency measurement is complete so that the CPU 470 can read the data from the counting circuit.

Note that the gating logic can be accomplished in many ways. For example the gating pulse could be inverted and then combined with the Clock signal through an OR gate instead of an AND gate 465. Alternatively, the gated pulse could be used as an enable line for the output of the HF Clock 466. As an additional alternative, the high frequency clock signal 467 can be sent directly to the Counting Circuit 469, where the Counting Circuit starts and stops its pulse counting based on the high and low transitions of the Gating Pulse 464. Since digital logic can be programmed in many ways with the same operational result, the scope of this patent covers all variations of analog and digital circuitry that accomplish substantially the same result, i.e. using a gated high frequency clock signal to count the cantilever frequency with higher resolution than previously used methods.

FIG. 9 shows a simplified schematic diagram of a device and a method to change the effective quality factor Q of an oscillating cantilever to enhance the sensitivity of ac mass detection experiments. The method of detected target substances by measuring the shift in cantilever resonant frequency has been described in the prior art and shown in FIG. 1. One method of measuring shift in cantilever resonance is by using a feedback loop to keep the cantilever always oscillating at resonance. One method of providing this feedback loop is to measure the phase lag of the cantilever versus the oscillating drive signal and to try to maintain a fixed phase relationship of 90° between these signals. This technique is used in magnetic force microscopy and electric force microscopy and is commercially available from Digital Instruments/Veeco. This technique has also been described in U.S. Pat. No. 6,041,642.

The feedback loop will typically be able to maintain the phase relationship to some specified accuracy, perhaps 0.1 degree. The accuracy of the resulting measurement of the cantilever resonant frequency then depends on the relationship between the cantilever oscillation frequency and the phase, specifically the slope of the phase versus frequency curve near the 90° point. Typical curves relating cantilever oscillation amplitude and phase versus frequency are shown in FIG. 9a. The left top curve 900 schematically shows an amplitude versus drive frequency relationship for a low quality factor (low Q) resonance. The lower left curve 902 shows the corresponding phase relationship. A phase based feedback loop will shift the drive frequency back and forth as necessary to try to maintain the phase difference at 90° and thus maintain the cantilever at resonance. The accuracy of the resulting frequency measurement depends on the slope of the phase versus frequency curve. A cantilever with a low quality factor Q will be limited in the accuracy of the resonant frequency measurements.

The right curves 904 and 906 in FIG. 9a shows amplitude and phase versus frequency for a higher Q resonance. Note the steeper slope of the cantilever phase versus frequency. Therefore, with a given accuracy of the phase feedback loop, more accurate measurements of cantilever resonant frequency can be measured with a higher Q resonance.

Before discussing the details of the improvements in this disclosure, we will discuss the simplified mathematics that govern an oscillating cantilever. An oscillating cantilever behaves similarly to the well-known forced/damped harmonic oscillator. The equation of motion for this system follows Netwon's law ΣF=ma (sum of the forces=mass times acceleration) and is given by the differential equation:

md²z/dt²+cdz/dt+kz=F₀cosωt

It is useful to discuss each of the terms in this equation briefly. The first term contains the cantilever mass times acceleration. The second term represents the damping force, where there is a damping force that is proportional to the velocity of the cantilever dz/dt. The third term kz represents the spring restoring force, where k is the spring constant and z is the cantilever deflection. The final term F₀cosωt corresponds to oscillating drive force.

The solution of this equation can be written as a function of drive frequency ω:

More importantly to this discussion, the phase angle δ as a function of frequency is given by:

δ=tan⁻¹(ωω₀/(Q*(ω₀²−ω²))

where ω is the frequency of drive oscillation, ω₀ is the cantilever resonant frequency, and Q is the above mentioned Quality factor of the resonance.

The slope of the phase versus frequency curve close to ω=ω₀ (90° phase point) is given by:

dδ/dω=−2Q/ω₀

As shown schematically in FIG. 9a, this result indicates that when using phase based feedback, high Q values produce the highest resolution measurements of the cantilever resonant frequency.

Normally the Q value is an intrinsic value of an oscillation system, determined by the amount of damping force. However, we need not be bound to these results. Instead, we can add an additional time-varying signal to the cantilever that modifies the equation of motion and modifies the apparent Q of the cantilever oscillation.

Back to the standard equation of motion:

md²z/dt²+cdz/dt+kz=F₀cosωt

The Q of the cantilever resonance is given by Q=ω₀/c, where c is the damping coefficient preceding the cantilever velocity term dz/dt, and ω₀ is the resonant frequency of the cantilever.

We can modify the Q of the cantilever oscillation by adding another oscillating force that is proportional to the cantilever velocity dz/dt. The resulting new quality factor Q is given by:

Q′=ω₀/(c+Δc)

Where Δcdz/dt is the amplitude of the new force we apply to the cantilever. The new cantilever quality factor Q′ can be adjusted over a wide range depending on the amplitude of Δc. When it is desired to make very sensitive measurements the cantilever Q′ can be adjusted to a very high value. In the extreme case the new force term Δc would be equal and opposite to the damping term c, resulting in an infinitely large Q.

Increasing the Q also makes the cantilever proportionately slower to change its amplitude in response to changing drive or resonant frequency. If on the other hand it is desirable to provide a cantilever that can change its amplitude very quickly, the term Ac can be made a large positive value to reduce the cantilever Q to an arbitrarily low value.

FIG. 9b shows a simplified schematic Q control 907 diagram for a method and a device for controlling and/or changing the Q of an oscillating cantilever for the purpose of more sensitive ac mass detection. A sinusoidal oscillation signal is generated by the Oscillator block 908. This oscillation signal is passed through a summing circuit 910 (denoted by a sum symbol Σ) and then to an optional low pass filter and power amplifier 912. Next, the oscillation signal is sent to the oscillation transducer 914 which is mechanically coupled to the cantilever 916 under study such that the motion of the transducer can generate a responding oscillation of the cantilever. The motion of the cantilever is measured by the optical lever method discussed in this specification or any other technique that can detect sufficiently small motions (detectors based on detecting capacitance, electrostatic forces, optical interference, magnetic flux, piezoelectric forces etc.) The output of the detector 918 should be a signal that is proportional to the time varying position of the cantilever as a function of time, z(t). This signal z(t) is once again referred to as the deflection signal and will have the form:

z(t)=A₀cosωt

The deflection signal is then usually sent to a bandpass filter 920 that is used to select the frequency range over which the Q-control circuit 907 will operate. The filtered signal is sent to a phase shifter 922. It is the phase shifter that generates a signal that is proportional to the cantilever velocity dz/dt. Normally to obtain this signal dz/dt one would send the deflection signal through a differentiator circuit. And Q-control can be implemented in such a way. However, differentiators tend to add noise to the system. Instead we take advantage of a couple trigonometric identities dcosθ/dθ=−sinθ and sinθ=cos(θ−90°). This indicates that for a sinusoidal signal like our cantilever oscillation A₀ cosωt, we can generate a signal that is proportional to the cantilever velocity dz/dt by phase shifting the coscot term by ±90° to turn it into a sine term. Essentially a phase shifter can replace the differentiator circuit for sinusoidal signals. Next, this new velocity term is scaled as desired in an adjustable gain stage 924. This gain stage determines the amplitude of the new oscillating force that will be added to the cantilever. After the gain stage, the resulting signal is added through the summing junction 910 to the signal going to the oscillation transducer 914. Depending on the gain and the sign of the gain, the resulting addition to the actuator signal can enhance or diminish the Q value.

Note it is also possible to use a separate oscillator transducer for the original oscillation and the velocity addition. In this case no summing junction is required, the phase shifted signal is simply scaled and sent to the separate transducer.

FIGS. 10-14 show simplified schematic diagrams of the preferred and alternate methods and devices for measuring the phase and/or dissipation of one or more oscillating cantilevers. The phase of an oscillating cantilever is related to the amount of damping affecting the cantilever. The damping can be the result of dynamic forces exerted on the cantilever by any surrounding media (both air and aqueous fluids create substantial and measurable damping forces), or the damping can be the result of internal dissipation forces generated by the cantilever or any coating or material on the cantilever. Since dissipative forces can occur at the atomic and molecular scale, this device can provide ftmdamental information about the atomic and molecular scale properties of materials under study.

FIGS. 10a-c show the preferred device and method for measuring the amount of dissipation felt by one or more cantilevers. When an oscillating cantilever is under the influence of dissipation or damping, energy must constantly be injected into the system to keep the cantilever oscillating at a fixed frequency. If the injected energy is removed, the cantilever amplitude will drop over time in an envelope called “Free decay.” For linear systems the shape of the free decay corresponds to an exponential decrease in time as shown schematically in FIG. 10a as waveform 1080 and from actual measured data 1090 in FIG. 10b. The shape of the decay envelope 1081 follows the equation:

A(t)=A₀e^{-π}(t−t0)/(Qτ)

where A(t) is the amplitude as a function of time (t), A₀ is the oscillation amplitude at t=t0, Q is the quality factor of the oscillation, and τ is the oscillation period. The quality factor Q is directly related to the amount of damping and can be related mathematically to dissipation forces and physical properties like viscosity.

A schematic block diagram for one method of making this Q measurement is shown in FIG. 10a. In this scheme the cantilever deflection signal 460 is sent into an Amplitude Demodulation 1082 circuit and the resulting cantilever amplitude is sampled by an analog to digital converter (A/D) 1083. The A/ID sends the resulting measurements to the computer or CPU 1070 which can calculate the resulting Q factor, viscosity, dissipation force or any related parameter. The CPU 1070 may also control the oscillation drive amplitude 1084 and/or frequency as previously discussed. The frequency can also be measured and used to calculate the Q factor and related dissipation parameters.

Note that this free decay measurement can be performed in a variety of methods. The high speed deflection signal can be directly sampled into the A/D 1083 without using an amplitude demodulator. Sample data of this type is shown in FIG. 10b. The data can then be curve fit by a computer to extract the decay time. One means for doing this is shown in FIG. 10c. In this case, the RMS value of the cantilever amplitude is plotted on a log scale so that the decay appears linear. The slope of the decay 1091 represents the amount of damping. High amounts of damping (and low Q factor) will give a very steep decay. Low damping (high Q) will give much slower decay. It is also possible to measure the cantilever amplitude at any two or more points in time and then calculate the Q factor from the exponential decay equations.

Note that the determination of the RMS amplitude and the frequency measurement may all occur internal to the computer. For example National Instruments Lab View software provides software functions to extract these parameters from a sampled waveform.

FIG. 11 shows a simplified conceptual diagram for the measurement of phase lag by measurement of the time delay between the transducer drive (reference) oscillation 1100 and the resulting cantilever oscillation 1101. When the cantilever is excited by a oscillating transducer, there is always some delay due to the accumulation of mechanical and electronic delays in the system. The amount of this delay will change in response to increased or decreased mechanical damping. This provides an additional means for measuring the dissipation forces of the cantilever and/or of coatings on the cantilever. The amount of the phase lag can be measured in numerous ways including standard outputs from commercial lock-in amplifiers, as produced by Digital Instruments/Veeco, phase comparator devices, analog and digital time measurement circuits, and other similar means.

The technique of measuring time delay to determine dissipation does have disadvantages over the preferred embodiment shown in FIGS. 10a-c. The reason is that the phase lag is also a function of cantilever resonance versus the drive oscillation frequency. Thus phase can change even if there is no change in cantilever dissipation forces. For example, if the cantilever is driven at a fixed frequency, but the cantilever resonance frequency shifts (say due to material adsorbing on the cantilever or environmental effects) the phase of the output signal will change. Since it may be more complicated to separate out the effects of resonant frequency change and changes in damping, the free decay method of FIGS. 10a-c can be more advantageous. Free decay also uses large quantities of amplitude decay data to fit a logarithmic curve, resulting far more accurate measurement of the dissipation than other methods. Further more, as the oscillation drive force is shut down ( or self resonance loop is opened) the free decay resonance frequency is independent of any means of drive and reflect only the intrinsic mechanical properties of the cantilevers FIG. 12 shows a simplified conceptual drawing of a method and a device for measuring the dissipation of a material coated or deposited on a cantilever. One of the challenges of cantilever based measurements is that the deflection and oscillation properties of micromechanical cantilevers can be easily affected by environmental parameters like temperature, viscosity of the gas/fluid media, pH, humidity, etc. FIG. 12 shows the use of a reference cantilever 1200 which is used to eliminate or substantially reduce these effects. In this arrangement, a material under study is coated, deposited or adsorbed onto one or more other cantilevers. For simplicity a single measurement cantilever 1202 is shown with a sample under study 1204 coated onto the surface of the cantilever. Then, to make precise measurements of the dissipation caused by the sample under study, the amount of damping of the measurement cantilever 1202 is compared to that of reference cantilever 1200. In the phase lag method described in FIG. 11, the relative dissipation can be measured by the relative phase between the measurement cantilever(s) and the reference cantilever. In the preferred method the slope of the free decay curves can be compared. The differential amount of decay is related to the damping from the sample under study 1204. Of course multiple reference cantilevers and multiple measurement cantilevers can be used.

FIG. 13 shows a simplified schematic diagram of a method and device for measuring the viscosity of a media surrounding an oscillating cantilever. Viscosity measurements are of tremendous commercial importance because viscosity critically affects the flow and damping properties of fluids. The micromechanical cantilevers 16 of this device can be used to make extremely sensitive measurements of viscosity and can make viscosity measurements on extremely small volumes of fluid. For example, this device can be made with internal flow volumes as small as a few micro liters, allowing viscosity measurements at the scale previously unavailable. In this technique, the gas or liquid under study 1300 is introduced into the flow cell so that it surrounds the cantilever. The preferred technique for these measurements is the free decay technique described in FIGS. 10a-c. A high viscosity media will cause a quick decay of the cantilever amplitude as shown in waveform 1302. A low viscosity media will cause smaller damping forces and the waveform 1304 will decay more slowly. The decay rate can be correlated qualitatively or quantitatively to the viscosity of the media under study. The phase lag method of FIG. 11 can also be used with appropriate calibration. For more accurate measurements, a differential measurement can be made. In this case, the Q factor is measured once with the flow cell filled with a media of known viscosity (or evacuated and with no media), and then the cantilever Q factor is measured again with the flow cell filled with the media under study.

FIG. 14 shows an alternative embodiment where the cantilever 1400 is oriented with its wider dimensions perpendicular to the direction of oscillation. In this case the dissipation forces measured by the cantilever are largely the result of transverse friction between the fluid and the cantilever, rather than the result of dynamic forces associated with moving larger volumes of fluid. Similar embodiment which uses torsion oscillation mode of the cantilevers may also minimize the fluid mass effect.

FIG. 15 shows a simplified schematic diagram of a feature of the measurement system where the angle of the reflected light beam(s) is independent of the index of refraction of the fluid. In most atomic force microscopes, the cantilever 16 is held at a slight angle (perhaps 10°) to make it easier to bring the tip of the cantilever into contact with a sample surface. In this arrangement, the incoming light beam is often perpendicular and the outgoing beam strikes the window at an angle. Once the reflected light beam hits the window it will bend (refract) in the case that the window has a different index of refraction than the media in the flow cell. The amount of bending depends on the difference of the index of refraction between the window and the media. The problem is that users may want to perform tests both in gaseous and liquid environments. Adding liquid to the flow cell changes the index of refraction and causes the angle of the reflected beam to change. If the reflected light beam is aligned to the detector when the flow cell is filled with gas, it may not be possible to make measurements when liquid is introduced without changing the alignment of the detector in prior art systems.

In the current system, however, the cantilever(s) 16 may be aligned parallel to the window surface. In this arrangement, optical symmetry maintains the angle of the outgoing beam equal to the angle of the incoming beam, independent of the index of refraction of the media in the fluid cell. By maintaining the angle of the outgoing light beam, measurements of cantilever motion may continue even immediately following the introduction of liquid.

FIG. 16 shows a simplified schematic diagram of a method and a device to compensate for the change in light beam focus position upon introduction of liquid into the system.

The introduction of a liquid with a different index of refraction than air has another effect-shifting the focus point of the light beam. This is shown schematically in FIG. 16a. As converging light passes into a media with and index of refraction greater than 1, the rate of convergence decreases and causes the focus point to occur at a point past the normal focus point in the absence of the media. The glass window 1600, for example, has this effect. The addition of any liquid into the flow cell also has this effect. So the introduction of liquid 1602 into the flow cell causes the focus of the light beam to be at a different point than if the flow cell is filled with gas. Fortunately, the amount of the focus shift is easily predictable knowing the index of refraction of the liquid, the index of refraction of the window, and the distance that the light beam travels in the liquid before striking the cantilever. Further, it is possible to compensate for this focus shift with an additional optical component 1604 as shown in FIG. 16b. In the simplest case, one can add a piece of compensation glass 1604 on top of the window 1600 when the flow cell is filled with gas. The thickness H of the compensation glass 1604 is selected so that it moves the focus of the light beam by the same distance that adding liquid to the flow cell will. When fluid 1602 is added to the flow cell, the compensation glass 1604 is removed to maintain the focus of the light beam at the place of the cantilever array.

If the liquid 1602 and the compensation glass 1604 had the same index of refraction, the compensation glass would be the same thickness as the liquid thickness above the cantilever. In practice the compensation glass 1604 will typically have a higher index of refraction and thus require a smaller thickness than the fluid thickness. It is also possible to perform this compensation using more complex optical elements like convex or concave lenses or lens systems.

FIGS. 17a-c shows a simplified schematic diagram of one embodiment of an optical measurement system 1700 used to measure the motion of the cantilever 16 or cantilever array. This figure shows two improvements to the optical lever technique to allow the use of smaller, more sensitive detectors and accommodate measurements of multiple cantilevers. First, FIGS. 17a-c shows; (1) the use of an asymmetric aperture 1702 to limit the size of the light beam and allow the use of a smaller and more sensitive detector, and; (2) the use of a cylindrical lens 1704 to both reduce the beam size of an individual light beam and to collect multiple parallel beams onto a single detector. The use of the cylindrical lens 1704 will be shown in more detail in FIG. 18.

The reason for the use of an asymmetric aperture 1702 comes from the desire to measure the motion of multiple cantilevers and the properties of the photodetectors, especially lateral effect photodetectors. To measure the motion of multiple cantilevers it is necessary to provide a detector 1706 that can sense the motion of each cantilever separately. In the preferred embodiment, the light from an array of laser diodes 1708 is directed onto an array of cantilevers 1710. Vertical Cavity Surface Emitting Lasers (VCSELs) for example are commercially available in arrays with a pitch of 250 um. It is convenient to manufacture cantilever arrays with this exact same pitch so that the laser beams from the VCSEL array can be imaged directly onto the cantilever without complicated optics.

The optics, however, must accommodate the fairly wide spacing of the array of laser beams from the VCSEL. If, for example, we wish to measure the motion of 8 cantilevers with a spacing of 250 um, the spread in the laser beams as they leave the VCSEL will be (8-1)*250 um=1750 um or 1.75 mm. In the simplest case, one would construct optics that could handle this beam spread plus the divergence of each individual beams. For VCSELs, the typical divergence angle is 6-8° half angle. This is a relatively large divergence and would require the focusing optics and more importantly the detector to be rather large. For example, if the detector 1706 was placed at a distance 50 mm from the focus spots on the cantilevers, the vertical size of the laser spot on the detector would be:

50 mm*2*tan8°=14 mm

This would mean that the photodetector 1706 would have to exceed 14 mm just to keep the spot on the detector. To allow sufficient room for measurement of cantilever deflections, it might be desirable to use a lateral effect photodiode with a vertical dimension of 20 mm. This large size has disadvantages as will be demonstrated below.

Lateral effect photodetectors produce current signals that are given by:

I₁=(PS/2)*(1+2Z/H)

I₂=(PS/2)*(1−2Z/H)

Where P is the optical power of the light source, S is the sensitivity of the photodetector in Ams/watt, Z is the vertical position of the light beam on the detector and H is the vertical height of the photodetector.

The difference between I₁ and I₂ is given by:

I₁−I₂=2PSZ/H

Motions of the cantilever 16 are determined by measuring this differential current. That means that the sensitivity of the detector system is given by:

d(I₁−I₂)/dZ=2PS/H,

This equation shows that the sensitivity is inversely proportional to the vertical height H of the detector 1706. So for high sensitivity, it is desirable to make the detector as small as possible. In addition, the noise and the capacitance of a photodetector generally increases with the surface area of the detector. This means that larger detectors will limit the fundamental sensitivity and response time of the optical measurement system.

To overcome these problems, it is advantageous to use an aperture to “stop down” the incoming laser beam. This has the advantage of decreasing the divergence angle of the light beams in the vertical direction and allowing the use of a smaller detector. It also can provide for better focusing of the laser spot since the optical elements will be limited to refracting the beams through smaller angles. (Optical aberrations can become larger at high angles of incidence.) In the preferred embodiment of this device, an asymmetric aperture 1702 is used to allow each beam of the laser array to pass through in the horizontal direction while stopping down the beams in the vertical direction. Stopping down the beams to 4° for example will allow the use of a 10 mm photodetector, twice as sensitive as a 20 mm photodetector. Since the light beam profile carries most of the intensity in the center of the beam it is possible to cut down the divergence angle and therefore detector size without losing too much light to make the measurement. The asymmetric aperture 1702 may be rectangular, elliptical or any similar extended shape that lets multiple beams pass in the horizontal direction while blocking a portion of the light in the vertical direction. (Once again, these directions are arbitrary and correspond to definitions given for convenience at the beginning of this specification.

FIG. 17a-c show the effect of the asymmetric aperture 1702 in three different views. FIG. 17a shows the laser beam unobstructed by the aperture (a single beam shown for clarity). The section view in FIG. 17b shows a portion of the light beam blocked in the vertical direction and the beam past the aperture having a smaller divergence angle than the incoming beam. The perspective view in FIG. 17c shows the light beam incident on the asymmetric aperture 1702 in a 3-dimensional view.

FIG. 18 is a schematic diagram showing the effect of placing a cylindrical lens in the path of the beams reflected from the cantilevers. Since the cantilevers deflect substantially in one direction, the perpendicular motion of the beams is not relevant to most measurements. This allows a single axis photodetector to be used. The cylindrical lens 1704 is used to compress both the individual light beams and the separation between beams in the horizontal axis, allowing the use of a smaller, faster and lower noise detector. The effect of the cylindrical lens 1704 is a little complex to show graphically since the incoming light consists of an array of many diverging beams. To make this effect easier to understand, we will divide the problem into three steps: (1) tracing the paths of the central axis of each light beam, (2) tracing the divergence and reconvergence of the central beam, and (3) tracing the central axis and the divergence and convergence of the extreme beams.

The 2-dimensional views in FIG. 18 are similar to the view that would be seen in a top view looking down on the cantilever array, as shown in FIG. 17a. For this illustration, however, the cantilever array 1710 is not shown for clarity. Instead, in FIG. 1 8a the central axis of eight individual light beams are shown schematically as dark lines. These represent the central axes of light beams reflected off 8 cantilevers 16 in the laser array. Since these light beams originate from a parallel array of light sources, the center lines of the light beams will converge at a point corresponding to the focal point f of the cylindrical lens. If, however, the detector 1706 is not placed at the focal point of the lens, then the spread of the laser beams at the detector will have a finite size wₐ.

FIG. 18b shows the divergence and then re-convergence of a single beam reflected off a cantilever 16 near the central axis of the lens as shown in FIG. 17c. The light beam will be focused at a spot s past the focal point of the lens where s is given by standard lens equations. If the detector 1706 is placed at the convergence point s, then the detector would need only to be big enough to allow for the spread of the laser beams from the laser array. If, however, the detector 1706 is placed at another location, then each light beam will have a finite size w_{b} as shown in FIG. 18b. In this case, the detector must be sized to account for both the spread of the light beams in the array wₐ and the finite size of the individual light beams w_{b}.

The combination of these effects is shown schematically in FIG. 18c. In this figure the two extreme light beams are shown. The minimum size of the photodetector w_{d} is given by the sum of wₐ and w_{b} from the previous figures.

With this is mind, the design can be optimized to select the system parameters that allow the detector size to be minimized. Best performance is achieved with a 12.7 mm cylindrical lens placed 20-30 mm from the cantilever array and 30-20 mm from the detector. This results in a detector with a horizontal size of 0.5-2 mm, in the range of readily available commercial detectors. Without the cylindrical lens, the detector would have to be >14 mm wide, which would have to have at least at least 7× the capacitance and perhaps more than 2.5× the noise and be substantially more expensive. The exact position of the cylindrical lens can be positioned depending on the system requirements, but the optimal placement of the cylindrical lens can be determined easily using optical design software like Zemax from Focus Software, Inc. For the best performance it may be desirable to use 2 or more cylindrical lenses to condense the light beams so that the focusing power is split between multiple lenses, thus reducing the total aberration introduced by the lenses. Further, the width of the asymmetric aperture shown in FIG. 17 may also be reduced to decrease the numerical aperture of the light striking the cylindrical lens or lenses. Reducing the numerical aperture of the light incident on the cylindrical lenses will also reduce the total aberration. A round aperture, mounted after the laser can accomplish the same thing, although this will attenuate the extreme lasers in a laser array more than those lasers in the center. . Combining these ideas allows a detector size of roughly less than 1 mm in size, though with a much smaller depth of field, requiring more accurate placement of the detector.

FIG. 19 shows a simplified schematic diagram outlining three optional features of the preferred embodiment, (1) a self-aligning flow cell 1900 (2) an oscillation actuator 1914 mounted outside the flow cell and (3) a system 1904 for controlling the temperature of the cantilevers and flow cell.

It is an object of this invention to provide a device that is robust and easy to use. For that reason, the flow cell is indexed so that it can be easily removed and replaced without need to readjust the measurement lasers. This is accomplished by building a kinematic mounting system into the measurement head and flow cell. This can be accomplished with a variety of schemes including the use of locator pins, springs, magnets, etc. In the preferred embodiment, the bottom 1906 of the flow cell 1900 is manufactured to have three mounting points 1908 consisting of a conical hole, a V-groove, and a flat region (only two of three shown). These three mounting points will mate with appropriately placed balls to exactly and uniquely locate the flow cell. This is accomplished by exactly constraining the position of the flow cell in all six degrees of freedom (3 translation axes, 3 rotation axes). Alternative kinematic mounting schemes exist including machining 3 V-grooves that aim toward a central point. Any scheme that constrains all six degrees of freedom without either under-constraining or over-constraining any degree of freedom will accomplish the object of having a self-aligning flow cell.

FIG. 19 also shows a simplified schematic diagram of a temperature control system 1904. The cantilever array and any gas or fluid sample entering the flow cell can be heated, cooled, or maintained at a controlled temperature. A temperature measuring device 1910 is inserted into the flow cell or in thermal contact with the base 1906 of the cell. A heater and/or a cooler 1912 can also be attached to the base 1906 in close proximity to the cantilever array. An ideal temperature control component for this is a Pettier device, a semiconductor device that will heat or cool one surface relative to the other surface depending on the direction of current flow. The temperature adjusting device can also be a resistive, inductive, or radiant heater, or based on the circulation of heated fluid or gas. Coolers could be based on refrigeration or the controlled flow of a cold fluid. Temperature measurement devices are well known including thermistors and thermocouples. The temperature measurement device generates a signal that is sent to a the Temp. Control unit 1904. This unit may be a separate and dedicated device or may be part of the Data Acquisition and Control Module. The Temp. Control unit 1904 will output a signal to a heater, cooler or both to maintain the temperature at a desired value.

FIG. 19 also shows one potential placement of a oscillation actuator 1914 used to oscillate the cantilevers for AC measurements. The oscillation actuator 1914 is shown mounted outside the flow cell 1900 and away from any fluids in the flow cell 1900. Fluids used in these sorts of experiments are often corrosive and incompatible with electrical devices. For this reason it is usually necessary to isolate or insulate the oscillation actuator 1914 from the fluid. In the preferred embodiment, the oscillation actuator 1914 is under the flow cell and under a ball bearing 1916 that is used to kinematically locate the flow cell at one of the mounting points 1908. The mounting arrangement will be described in more detail later. The advantage of this placement is that the transducer can excite resonances of the cantilever without being exposed to the fluid in the fluid cell. For many operation frequencies, the transducer 1914 can be placed at a variety of other locations—on the flow cell, cell window, cell clamp, on the measurement head, etc. The oscillation transducer 1914 is typically a piezoelectric device where an applied voltage generates a corresponding motion. In the preferred embodiment this transducer 1914 is a piezoelectric stack, bimorph or simply a piece of a piezoelectric crystal. The transducer 1914 could also be an electrostrictive, electrostatic, or magnetostrictive device, a voice coil, or any other device that produces a motion in response to an applied signal.

FIG. 20 is a simplified schematic diagram of the preferred embodiment showing the mounting and exchange of a cantilever sensor 2000, and a tool to simplify this process. In the preferred embodiment the cantilever array 2002 is attached to a mounting stub 2004 made of magnetic stainless steel.

The stub 2004 has cutout which provides a mounting pocket or mounting ledge 2006 for the cantilever. This provides easy alignment for the cantilever when it is being attached to the mounting stub. In addition, if the cutout is the same depth as the cantilever, any fluid flowing through the flow cell will encounter a smooth surface with minimal potential dead volume. The cantilever mounting stub 2004 may be placed flat against the bottom 2008 of the flow cell, or in the preferred embodiment it is aligned using a kinematic mounting scheme 2010 as previously described. The mounting stub 2004 may also be mounted in a semi-kinematic manner, one that uniquely determines the horizontal position of the cantilevers (the direction most critical for alignment with the array of light beams) without kinematically determining the vertical position. For small mounting stubs, the vertical position of the cantilever array 2002 will be sufficiently stable and repeatable if the stub and the flow cell bottom 2008 are both carefully machined. In this case the horizontal position of the mounting stub 2004 could be determined by locator pins and/or other location features machined into the flow cell base.

FIG. 20 also shows a tool 2012 and a method for exchanging the cantilever arrays. The cantilever mounting stub 2004 is held in place by a magnet 2014 we will refer to as a “medium magnet.” A special cantilever exchange tool 2012 is constructed with two other magnets, a “small magnet” 2016 and a “large magnet” 2018. The magnet names suggest their relative magnetic strength. To install a cantilever array 2002 into the cell, the mounting stub 2004 is attached to the small magnet 2016 on the exchange tool 2012. Then when the tool 2012 is brought close to the bottom 2008 of the flow cell, the cantilever array mounting stub 2004 will be transferred to the medium magnet 2014 and the array 2002 is installed. To remove a cantilever array, the tool 2012 is reversed (or a separate tool is used) so that the larger magnet 2018 can pull the stub off the medium magnet 2014.

FIG. 21 shows a method and a device for allowing self-calibration of the cantilever sensor system. The position sensitive detector shown in previous figures detects a position of the light beam incident on the detector. The measured quantity of interest, however, is the cantilever deflection, angle, or oscillation amplitude, for example. To determine any of these properties accurately it is necessary to know the calibration sensitivity between motion of the reflected light beam on the detector and the motion of the cantilever or cantilevers. This specification provides an apparatus and a method for manually or automatically determining this calibration sensitivity.

The calibration sensitivity is proportional to a number of system parameters including the optical power of the light source, the distance to the detector, and the position of the focused light beam on each cantilever. With atomic force microscopes this sensitivity is usually measured experimentally by bringing the AFM cantilever into contact with a sample surface, moving the sample by a known amount, and then recording the change in position of the light beam on the detector. In the current device, the cantilever is not generally in contact with a solid sample. A test sample and means to move the sample can be included in the device to accomplish the calibration similarly to the AFM. We have also determined another simpler way to provide the calibration sensitivity. The microscope objective and camera 2102 shown in FIG. 21 provide means for detecting the exact position of the light beam on the cantilevers. In the preferred embodiment, the output of the camera 2102 is sent to a video frame grabber 2100 which can capture one or many image frames from the camera 2102. Then either a user or a software algorithm can determine the position of the light beam relative to the fixed end of each cantilever. From this distance, the calibration sensitivity of the optical detection system can be calculated. In the preferred embodiment this calibration could be done automatically by a computer either at periodic intervals or whenever triggered by the user. In a simplified implementation, the user can position a cursor 2104 over the position of the laser spot(s) 2106 and the position of the fixed end of the cantilever 16. The separation of these two points can be automatically determined by the computer or determined manually by the user. Once this separation is known, the calibration sensitivity can be determined.

Other variations and modifications to the specifically described embodiments may be made without departing from the spirit and scope of the present invention. With that in mind, the invention is intended to be limited only by the scope of the appended claims.

What is claimed is:

1. A cantilever sensor measurement head comprising:
a cantilever array with at least two cantilevers;
a light source that directs a beam of light onto a cantilever in the cantilever array;
a position sensitive detector that receives light reflected off the cantilever; and
a cylindrical lens positioned in the path of the light beam reflected off the cantilever and between the cantilever and the position sensitive detector.

2. The cantilever sensor measurement head of claim 1, wherein the light source is capable of producing a plurality of light beams.

3. The cantilever sensor measurement head of claim 1, wherein each cantilever of the array receives a corresponding light beam.

4. The cantilever sensor measurement head of claim 1, wherein the light beams received by two different cantilevers of the array are different.

5. The cantilever sensor measurement head of claim 1 further comprising:
an asymmetric aperture positioned in the path of the light beam between the light source and the cantilever, wherein the aperture has a width greater than its height.

6. A cantilever sensor measurement head comprising:
a cantilever array having at least two cantilevers;
a light source that directs at least one beam of incoming light onto at least one cantilever within the cantilever array;
a position sensitive detector that receives light reflected off the cantilever; and
an asymmetric aperture positioned in the path of the incoming light beam and between the light source and the cantilever array, wherein the aperture has a width greater than its height.

7. An improved cantilever sensor measurement head comprising:
a cantilever array with at least two cantilevers;
a light source that directs at least one beam of light onto at least one cantilever within the cantilever array;
a position sensitive detector that receives a light beam reflected off the cantilever array;
a transparent window having top and bottom surfaces and wherein the window is positioned in the path of the incoming and reflected light beams; and
wherein the light source and the detector are positioned such that the incoming light beam and the reflected light beam make substantially the same angle with respect to top surface of the window.

8. The cantilever sensor measurement head of claim 4, wherein the angle of the light reflected off the cantilever is substantially independent of the index of refraction of any gas or fluid placed under the window.

9. The cantilever sensor measurement head of claim 4, further comprising:
one of a liquid, gaseous and vacuum medium between the cantilever and the window;
a lens to focus the at least one light beam onto a spot wherein the focused spot is substantially at the position of the cantilever when the cantilever is immersed in the medium;
a removable piece of transparent material that is used to compensate for a change in the focus position resulting from a change in the medium between the cantilever and the window.

10. The cantilever sensor measurement head of claim 6, wherein the removable mouthpiece is placed adjacent to the top surface.

11. A cantilever sensor measurement head comprising:
a cantilever array with at least two cantilevers;
a light source that directs at least one beam of light towards at least one cantilever within the cantilever array;
a position sensitive detector that receives a light beam reflected off the cantilever;
a transparent window having top and bottom surfaces and wherein the window is positioned in the path of the incoming and reflected light beams;
one of a liquid, gaseous and vacuum medium between the cantilever array and the window;
a lens to focus the incoming light beam onto a spot wherein the focused spot is substantially at the position of the cantilever array when the cantilever array is immersed in the medium;
a removable piece of transparent material that is used to compensate for a change in the focus position of the light beam resulting from a change in the medium between the window and the cantilever array.

12. A cantilever sensor measurement head comprising:
a cantilever array with at least two cantilevers;
a light source that directs at least one beam of light onto a mirror wherein the light reflected from the mirror is directed onto at least one cantilever within the cantilever array;
a position sensitive detector that receives light reflected off the cantilever array;
a transparent window having top and bottom surfaces and wherein the window is positioned in the path of the incoming and reflected light beams;
one of a liquid, gaseous and vacuum medium between the cantilever and the window;
a lens positioned to focus the incoming light beam onto a focused spot; and
wherein the mirror defines a concave reflective surface with a radius of curvature which substantially minimizes the size of the focused spot.

13. The cantilever sensor measurement head of claim 9, wherein the radius of curvature of the mirror minimizes the coma aberration introduced by the light beam passing through the window.

14. The cantilever sensor measurement head of claim 9, wherein the arrangement of the light source and the detector allow for substantially unobstructed optical access from the top of the measurement head to the cantilever array.

15. The cantilever sensor measurement head of claim 10, wherein the unobstructed optical access is used to provide access for spectroscopic measurements.

16. The cantilever sensor measurement head of claim 10, wherein the spectroscopic measurement includes the detection of gas concentration using infrared absorption.

17. A cantilever sensor measurement head comprising:
a cantilever array with at least two cantilevers;
a light source that directs at least one beam of light onto a mirror wherein the light reflected from the mirror is directed onto at least one cantilever within the cantilever array;
a position sensitive detector that receives a light beam reflected off the cantilever array;
a transparent window having top and bottom surfaces and wherein the window is positioned in the path of the incoming and reflected light beams;
one of a liquid, gaseous and vacuum medium between the cantilever and the window;
a lens positioned to focus the generated light onto a focused spot;
an optical video system to capture an image of both the cantilever array and the focused spot;
a computer to convert the position of the laser spot into a measurement of the calibration of the optical lever sensitivity of the measurement head for the cantilever.

18. A cantilever sensor measurement system comprising:
a cantilever array including a cantilever;
a detection system that generates a deflection signal indicative of deflection of the cantilever;
a clocking device that generates a clock signal having an associated frequency;
a gating circuit that generates a gating signal with a time width based on a selected number of oscillation cycles of the deflection signal; and
a pulse counter that counts a number of oscillations of the clock signal during the time width of based on the gating signal.

19. The measurement system of claim 18, wherein the selected number of oscillation cycles of the deflection signal is fixed.

20. The measurement system of claim 18, wherein the selected number of oscillation cycles of the deflection signal is programmable.

21. The measurement system of claim 18, further comprising:
a self-resonance circuit wherein the self-resonance circuit is arranged to oscillate the cantilever substantially at a resonant frequency of the cantilever.

22. A cantilever sensor measurement system comprising:
a cantilever array including a cantilever;
a detection system that measures a signal related to the bending of the cantilever;
an oscillation transducer that generates an oscillating drive signal;
a self-resonance circuit wherein the self resonance circuit varies the oscillating drive signal so as to maintain the oscillation of the cantilever at a resonant frequency of the cantilever.

23. The cantilever sensor measurement system of claim 22, further comprising:
a clocking device that generates a clock signal at an associated frequency;
a gating circuit that generates a gating signal with a time width based on a selected number of oscillation cycles of the deflection signal;
a pulse counter that counts a number of oscillations of the clock signal during the time width of the gating signal; and
a computer that determines the oscillation frequency of the cantilever based on the number.

24. The measurement system of claim 23, wherein the selected numberof oscillation cycles of the deflection signal is programmable.

25. A cantilever sensor measurement system comprising:
a cantilever array with at least one cantilever;
a detection system that generates a deflection signal based on bending of the cantilever;
an oscillation transducer; and
a Q-control circuit to modify the apparent quality factor of the cantilever.

26. A cantilever sensor measurement system comprising:
a cantilever array including a cantilever;
a detection system that generates a deflection signal indicative of deflection of the cantilevers;
a high frequency clocking device that generates a clock signal having an associated frequency;
a gating circuit that generates a gating signal with a time width based on a selected number of oscillation cycles of an oscillating cantilever;
a pulse counter that counts a number of oscillations of the clock signal; and
a gate that transmits the clock signal to the pulse counter during the time width of the gating signal.

27. A cantilever sensor measurement system comprising:
a high frequency clock that generates a clock signal at a selected frequency;
a gating circuit that generates a gating signal based on a selected number of oscillation cycles of an oscillating cantilever;
a pulse counter that counts a number of oscillations of the clock signal based on the gating signal.

28. A method for measuring the oscillatory properties of one or more cantilevers of a sensor array, the method comprising:
oscillating a cantilever array that includes at least one cantilever;
detecting a deflection of the cantilever and generating a deflection signal based on the deflection;
generating a clock signal having an associated frequency;
generating a gating signal with a time width based on a selected number of oscillation cycles of the deflection signal; and
counting a number of oscillations of the clock signal based on the gating signal.

29. The method of claim 28, further comprising the step of:
determining the oscillation frequency of the cantilever based on the number of oscillations.

30. A method for measuring the oscillatory properties of one or more cantilevers of a sensor array, the method comprising:
providing a cantilever array with at least one cantilever;
oscillating the cantilever array;
measuring a bending of at least one cantilever and generating a corresponding deflection signal;
modifying an apparent quality factor of the cantilever so as to increase the sensitivity of AC mass detection.

31. An apparatus for mounting a cantilever sensor array in a measurement head, the apparatus comprising:
a flow cell;
a mounting stub having a cutout that supports the cantilever sensor array, wherein the mounting stub is coupled to the flow cell; and
wherein the cutout facilitates alignment of the cantilever sensor in the measurement head.

32. The apparatus of claim 31, wherein the cutout has a depth generally equal to a thickness of the cantilever sensor.

33. The apparatus of claim 32, wherein one of a kinematic and a semi-kinematic mount aligns the mounting stub to the flow cell.

34. The apparatus of claim 31, wherein the stub is made of one of magnetic stainless steel and at least a portion of magnetizable material.

35. The apparatus of claim 31, wherein the mounting stub is coupled to the flow cell with a first magnet having a first magnetic strength.

36. The apparatus of claim 35, further comprising an exchange tool having opposed ends including second and third magnets, respectively, coupled thereto, wherein the second and third magnets having corresponding second and third magnetic strengths.

37. The apparatus of claim 36, where in the first magnetic strength is (1) greater than the second magnetic strength and (2) less than the third magnetic strength.

38. The apparatus of claim 37, wherein the cantilever sensor is coupled to the second magnet and then positioned approximately overhead of the first magnet such that the first magnet transfers the cantilever array to the mounting stub.

39. A method of mounting a cantilever sensor array in a m easurement head, the method comprising:
providing a magnetic mounting stub having a cutout;
coupling the mounting stub to a flow cell with a first magnet;
coupling a cantilever sensor array to one of opposed ends of an exchange tool including second and third magnets disposed at the opposed ends, respectively;
positioning the cantilever sensor array adjacent to the cutout such that the cantilever sensor array i s transferred to the cutout.

40. The method of claim 39, further comprising the step of removing the cantilever sensor array from the cutout by positioning the other of the opposed ends of the exchange tool generally adjacent to the cantilever sensor array.

41. The apparatus of claim 31, wherein the stub is made of PEEK or Teflon plastic.

42. The apparatus of claim 41, wherein the stub includes a piece of one of a magnetic and a magnetizable material.

43. A measurement chamber for a cantilever array sensor system comprising:
a flow cell having a base, an inlet port and an outlet port connected by a flow channel;
wherein the height and width of each of the inlet port and the outlet port are substantially equal to the height and width of the flow channel; and
a cantilever array having at least one cantilever mounted inside the flow cell.

44. The measurement chamber of claim 43, wherein the flow cell has an optically transparent upper surface.

45. The measurement chamber of claim 43, further comprising an end cap connecting each of the inlet port and outlet port to a hose fitting; wherein each end cap is tapered to prevent the presence of dead volume within the flow cell.

46. The measurement chamber of claim 43, further comprising:
a mounting stub which mounts the cantilever array within the flow channel of the flow cell;
a plurality of alignment pins disposed in the base of the flow cell within the flow channel, wherein the alignment pins align the mounting stub within the flow channel when the mounting stub contacts the alignment pins.

47. A measurement chamber for a cantilever array sensor system comprising:
a flow cell having a base, an inlet port and an outlet port connected by a flow channel;
wherein the length and width of the inlet port and the outlet port are substantially equal to the length and width of the flow channel;
a cantilever array having at least one cantilever mounted inside the flow cell;
a mounting stub which mounts the cantilever array within the flow channel of the flow cell; and
a plurality of alignment pins disposed in the base of the flow cell within the flow channel, wherein the alignment pins align the mounting stub within the flow channel when the mounting stub contacts the alignment pins.

48. The measurement chamber of claim 47, further comprising a temperature control device.

49. The measurement chamber of claim 48, wherein the temperature control device is a peltier heating and cooling device.

50. The measurement chamber of claim 48, wherein the temperature control device is a heater.

51. The measurement chamber of claim 47, wherein the mounting stub is magnetically attached to the flow cell base.

52. The measurement chamber of claim 47, further comprising a piezoelectric oscillator for oscillating the at least one cantilever, wherein the oscillator is external to the flow cell.

53. A measurement chamber for a cantilever array sensor system comprising:
a flow cell having an inlet and an outlet connected by a flow channel;
wherein the length and width of the inlet and the outlet are substantially equal to the length and width of the flow channel;
a cantilever array mounted within the flow cell;
a mounting stub which mounts the cantilever array within the flow channel of the flow cell; and
a plurality of alignment pins disposed in the base of the flow cell within the flow channel, wherein the alignment pins align the mounting stub within the flow channel when the mounting stub contacts the alignment pins.

54. A measurement chamber for a cantilever array sensor system comprising:
a flow cell with an inlet, and outlet and a flow channel;
a cantilever array with one or more cantilevers mounted inside the flow cell; and
a piezoelectric oscillator located outside the flow channel and therefore protected from damage by any fluid contained within the flow channel.
